(19) United States
(12) Patent Application Publication
(10) Pub. No.: US 2003/0028498 A1
(43) Pub. Date: Feb. 6, 2003

(54) Customizable expert agent

(76) Inventor: Barbara Hayes-Roth, Atherton, CA (US)

Correspondence Address: LUMEN INTELLECTUAL PROPERTY SERVICES, 45 CABOT AVENUE, SUITE 110, SANTA CLARA, CA, 95051, US

(21) Appl. No.: 10/167,233

(22) Filed: Jun. 7, 2002

Related U.S. Application Data
(60) Provisional application No. 60/296,868, filed on Jun. 7, 2001.

(51) Int. Cl. G06F 15/18

(52) U.S. Cl. 706/17

(57) ABSTRACT

The present invention provides a human-like customizable expert agent capable of having personalized conversational interactions with human users. The customizable expert agent combines natural language conversation, animated gestures, general expertise, and subject expertise to create enjoyable and effective online experiences in a variety of contexts. Each customizable expert agent is preferably a computer-controlled improvisational character having distinct personality, moods, and other life-like qualities. The customizable expert agent can act as a sales agent or a course coach and may proactively initiate a conversation with the user at any time. The present invention further provides an integrated software system and program products, including an application shell and an authoring tool, for desktop online application authoring and enterprise hosted web deployment. The customizable expert agent is particularly useful in providing computer-based training and coaching, and capable of assisting eCommerce customers in a variety of electronic transactions. The present invention operates over a computer network such as an intranet or the Internet utilizing client-server technologies.

### CROSS-REFERENCES TO RELATED APPLICATIONS

This application claims the benefit of U.S. Provisional Application No. 60/296,868, filed on Jun. 7, 2001, which is hereby incorporated herein by reference in its entirety. This application is related to: U.S. Pat. No. 6,031,549, “SYSTEM AND METHOD FOR DIRECTED IMPROVISATION BY COMPUTER CONTROLLED CHARACTERS”; U.S. patent application Ser. No. 09/464,828, filed on Dec. 17, 1999; and U.S. Provisional Patent Application No. 60/172,415, filed on Dec. 17, 1999; all three of which are hereby incorporated herein by reference.

### COPYRIGHT NOTICE AND AUTHORIZATION

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but other reserves all copyrights whatsoever.

### BACKGROUND OF THE INVENTION

1. Field of the Invention

This invention relates generally to a digital character with artificial intelligence and improvisational behaviors and other life-like qualities. More particularly, it relates to a computer-based customizable expert agent as well as software system and corresponding program products for customizing the expert agent's expertise for use in particular applications. The software system and program products utilize existing technology to enable conversational as well as other sorts of interactions between the customizable expert agent and real people. The customizable expert agent can operate over a local or global computer network, over a wireless network, or locally on a computer or a computer-enabled device. It has application-independent expertise and can be given application-specific expertise. It is capable of interacting with human users/learners/customers/trainees utilizing both types of expertise, much like a human expert agent.

2. Description of the Related Art

Digital characters are not new. The term “digital character” is sometimes used interchangeably with “animated character,” “simulated character,” “computer character,” and “virtual character.” Digital characters such as those commonly found in computer games that are not intelligent computer-controlled characters are distinguished from the present invention. It has been anticipated that “intelligent” or “smart” digital characters created and developed to interact on various levels with human users for a variety of purposes would be particularly beneficial to electronic sites, such as web sites on the Internet and various commercial electronic media including on-location electronic kiosks and automatic teller machines (ATM), and consumer electronic devices, such as phones and personal digital assistant (PDA). For example, an animated character might assist a bank customer in completing an electronic transaction at an ATM, help a shopper to purchase toys and books, etc., at a web site, or train a new manager on skills for delivering effective employee feedback. In the present application, the term “user” generally refers to a broad class of consumers, students, employees, business customers, business partners, and any category of people who might have occasion to interact with a virtual character. The sky is the limit of what might, in principle, be provided by these virtual characters.

Unfortunately, while development of intelligent digital characters, such as a digital customer service representative or an animated coaching agent, has been a research and development (R&D) activity for almost thirty years, until recently the general hardware and software technology infrastructure was not sufficiently advanced to develop and deploy computer-based characters with human-like expertise and interaction qualities. As a result, today's eCommerce, eLearning, and other electronic products and services still operate primarily in a self-service mode. For example, when shopping online, customers themselves search for products and related information using an on-site directory or a general-purpose search engine, search for answers and help using on-site frequently asked questions (FAQ) listings or help page, if available, and/or fill out electronic forms to complete a purchase, etc. Such impoverished self-serve experiences can be less than satisfying, especially compared to the traditional shopping experience in physical stores staffed with human sales assistants (customer service representatives). Similarly, today's eLearning products operate primarily in a self-service mode, where students must browse “books on the Web” for useful information, without the benefit of a teacher or coach to guide their learning, answer their questions, assess their knowledge and skills, provide individualized tutoring, or motivate and encourage Learners with personalized attention. ECommerce, eLearning, and other electronic products and services would be more effective if they were augmented by expert agents who could help users in the same ways that human sales assistants and human coaches help users in traditional environments.

Efforts have been made to enhance human-machine interactions. For example, U.S. Pat. No. 6,044,347, titled “METHODS AND APPARATUS FOR OBJECT-ORIENTED RULE-BASED DIALOGUE MANAGEMENT,” issued to Abella et al., and assigned to Lucent technologies Inc. of Murray Hill, N.J. and AT&T Corp. of New York, N.Y., USA, discloses a rule-based dialogue processing system capable of conducting efficient dialogue with a human user. U.S. Pat. No. 6,371,765 Bi, titled “INTERACTIVE COMPUTER-BASED TRAINING SYSTEM AND METHOD,” issued to Wall et al., and assigned to MCIWorldcom, Inc. of Jackson, Miss., USA, discloses an interactive computer-based training (CBT) system operable over a computer network for training users on equipment having hardware and software functionality. However, these interactive systems operate without computer-controlled intelligent digital characters. They do not have capabilities for projecting personality or social relationships with users. They are incapable of providing graceful mixed-initiative interactions, combining reactive responses to user-initiated dialogue with proactive behaviors to initiate dialogue based on their own goals and priorities. They do not “get to know” the user by remembering information revealed during interactions and reincorporating later in a given interaction or even on another occasion. Finally, they do not implement a general and useful form of expertise that can be complemented with alternative application-specific information to create a variety of particular expert agents ready to serve users in different domains.

U.S. Pat. No. 6,349,290, titled “AUTOMATED SYSTEM AND METHOD FOR CUSTOMIZED AND PERSONALIZED PRESENTATION OF PRODUCTS AND SERVICES OF A FINANCIAL INSTITUTION,” issued to Horowitz et al., and assigned to Citibank, N.A. of New York, N.Y., USA, discloses an automated system having an advice engine that provides proactive product and service messages to customers of a financial institution, such as a bank, through e-mail, voice messaging, and even sending a letter. Horowitz et al.'s advice engine consists of software tools for information and planning, guidance advice, marketing messages, and an alert engine. When the expertise of an agent is needed or intended by the customer, however, the automated system directs a customer service call to an appropriate human expert agent who has the requisite skills.

Some attempts have been made to combine the power of the computer with human expertise. For example, U.S. Pat. No. 5,412,756, titled “ARTIFICIAL INTELLIGENCE SOFTWARE SHELL FOR PLANT OPERATION SIMULATION,” issued to Bauman et al., and assigned to Mitsubishi Denki Kabushiki Kaisha of Tokyo, Japan, discloses a knowledge-based system, or expert system, that includes an artificial intelligence (AI) software shell particularly developed to incorporate expertise of plant operators for plant operation simulation. The expertise (knowledge) resides in a blackboard database that includes objects representing plant items. Expert system knowledge sources execute and modify specific objects in accordance with a temporal priority scheme. An end user views the status of these objects to diagnose and monitor plant operations. In Bauman et al., the users are plant personnel that interact with the expert system to receive recommendations and take appropriate action. The expert system of Bauman et al., however, does not provide an adaptive and personalized expert agent for mediating between the knowledge objects and the end user.

Adaptive and personalized agent based systems have been developed for use in travel arrangements, email management, meeting scheduling, stock portfolio management, and gathering information from the Internet, among others. More recently, agent based systems that can learn from experience have been developed for use in educational and instructional applications such as computer-assisted instruction (CAI) and computer-based training (CBT) applications. For example, a virtual tutor is disclosed in U.S. Pat. Nos. 5,727,950 and 6,201,948, both titled “AGENT BASED INSTRUCTION SYSTEM AND METHOD,” issued to Cook et al., and assigned to Netsage Corporation of Golden, Colo., USA. Cook et al.'s invention relates to an agent based instruction (ABI) system for CAI, the ABI system having agent software adapted to each student for providing individualized student interaction and or managing and controlling instruction in a manner approximating a real tutor. Cook et al.'s agent software interacts with each student through a virtual tutor that appears on-screen as “Study Buddies™”, for children or an objective “Concept Coach” for adults. Although the virtual tutor exhibits some intelligence and responsive behaviors, it has limited human-like quantities, does not offer proactive advice, and is not customizable for other types of agent applications.

Similar weaknesses can be found in other existing agent based systems, for example, U.S. Pat. No. 6,029,158, titled “SYSTEM, METHOD AND ARTICLE OF MANUFACTURE FOR A SIMULATION ENABLED FEEDBACK SYSTEM” and issued to Bertrand et al., and in U.S. Pat. No. 6,029,159, titled “SYSTEM, METHOD AND ARTICLE OF MANUFACTURE FOR A SIMULATION ENABLED ACCOUNTING TUTORIAL SYSTEM” and issued to Zorba et al., both of which are assigned to AC Properties B.V., Netherlands. Utilizing a rule based expert training system, these two patents disclosed an intelligent coaching agent (ICA) software for analyzing inputs and outputs to a simulation model and generating feedback based on a set of rules. The ICA is an artificial intelligence engine driving individualized and dynamic feedback with synchronized video and graphics used to simulate real-world environment and interactions. This feedback is received and displayed through the Visual Basic Architecture without the use of a humanized customizable expert agent.

Existing expert systems and products do not provide a proactive, efficient, effective, and customizable expert agent that thinks, behaves, speaks, and acts like a human expert agent. Each of the aforementioned prior art systems is specifically designed to solve a particular problem. Though an animated character is sometimes used, the character merely has the form and not the heart, expertise, or adaptivity of a human. More importantly, none of the existing agent based expert systems provide a simple and effective software tool or method for customizing the expertise of an agent for new applications. The present invention addresses this need by providing a computer-controlled customizable expert agent having application-independent and application-specific expertise, along with software tools and methods for customizing the agent's application-specific expertise.

### SUMMARY OF THE INVENTION

It is important to note that the present invention distinguishes from prior art systems and products that cannot communicate with humans in natural language. The present invention also distinguishes from prior art systems' and products that operate without intelligent computer-controlled characters having improvisational and proactive behaviors that reflect personality, mood, and other life-like qualities. A primary object of the present invention is to provide a human-like computer-based customizable expert agent. The customizable expert agent proactively interacts with, coaches, and otherwise assists human users/customers/learners much like human expert agents.

The customizable expert agent of the present invention is an intelligent computer-controlled digital character having improvisational and proactive behaviors as well as customizable expert knowledge, capable of proactive and interactive conversations with human users in natural language dialogue, capable of observing and learning about the users from the conversations and interactions, and capable of building a continuing relationship with each user. In a preferred embodiment, the expert agent's improvisational behavior is enabled by the AI technologies taught and described in the above-referenced U.S. Pat. No. 6,031,549, assigned to the assignee of the present application, Extempo Systems, Inc. (hereinafter referred to as “Extempo”), and titled “SYSTEM AND METHOD FOR DIRECTED IMPROVISATION BY COMPUTER CONTROLLED CHARACTERS,” hereinafter referred to as the “Imp Character” patent. Created and developed by the inventor of the present application, an Imp Character is a computer-controlled character that exhibits a broad range of interesting behaviors, including both physical and verbal behaviors, in a broad range of situations. The present invention advantageously utilizes the patented AI technologies to create customizable expert agents that can have personalized conversational interactions with learners/customers much like human expert agents. The customizable expert agent of the present invention combines natural language conversation, animated gestures, subject expertise, and access to various electronic resources to create enjoyable and effective online experiences in a variety of contexts. The preferred embodiment of the present invention operates over a computer network, e.g., a World Wide Web (web), utilizing client-server technologies. However, it will be apparent to one skilled in the art that the invention could operate entirely within a single computer or computer-enabled device as well.

Also like a human expert agent, who can deploy his or her general expertise to perform many particular jobs (e.g., an expert sales assistant selling many different products in many different departments or stores, or an expert coach helping many different learners to acquire many different types of skills), the computer-based expert agent has general expertise that it can deploy in many different jobs or applications. Deployment in particular applications is supported by customization of an agent's expertise to a particular site by integrating particular content or other application software. For example, an agent's expertise may be customized in the following ways:

Integration with a client system's own search engine, product database, or frequently-asked questions (FAQ) resource, along with site-specific information enabling the agent to translate a learner/customer's natural language request into an effective query.

Integration with a client system's transaction-support applications; for example, dynamic product displays, illustrations, charts, audio recordings, or animations, along with control information directing the agent to run particular applications in particular interaction contexts.

Customization of the agent's standard dialogue with site-specific information, such as company name, marketing tag lines, etc.

Extension of the agent's standard dialogue with application-specific dialogue to be delivered in particular interaction contexts.

Customization of global parameters of the interaction; for example, proactive energy, transaction pressure, or social chattiness.

Customization of the design parameters of the agent interface; for example, the color or shape of a border on the interface, whether the agent has a visual appearance or voice, etc.

Customization of the agent's persona; for example, the agent's background, emotional dynamics, sense of humor, political positions, or formality.

Such customization of the agent's expertise may be accomplished by different methods, including but not limited to the following: inserting the customization information directly into the agent's knowledge base; filling out fields in a template or form that indicates possible loci for possible types of customization information; arranging icons on an electronic diagram to specify the flow and parameters of an interaction, or providing the agent positive, negative, or other feedback during or after an execution of its expertise. It will be apparent to one skilled in the art that other interface designs and communication techniques could mediate input of application-specific information to augment application-independent information in order to customize an expert agent.

Following customization, a communication mechanism is provided at a client system (e.g., a selectable icon/button), allowing a customer to invoke the services of the customized expert agent. The software controlling the agent's behavior and dialogue may reside at the client or server. The server system may be local or remote to the client system and needs not be at the same location with computer systems hosting the electronic sites.

The principles as well as embodiments of the present invention will now be described in detail with reference to the following drawings.

### BRIEF DESCRIPTION OF THE DRAWINGS

FIGS. 1A-1P together demonstrates mix-initiative natural language conversations between two human learners and an expert Coach having application-independent coaching expertise and application-specific “people skills” expertise according to an embodiment of the present invention.

FIG. 2 illustrates a STOW Coaching Application Shell (CAS) Component Diagram in accordance with an aspect of the present invention.

FIG. 3 illustrates a general design structure of an application interface according to an embodiment of the present invention.

FIG. 4 illustrates a STOW Coaching Application Tool (CAT) Architecture in accordance with an aspect of the present invention.

FIG. 5 illustrates a STOW Coaching Application Tool (CAT) Object Hierarchy in accordance with an aspect of the present invention.

FIG. 6 is a diagram showing how STOW authoring sessions flow in accordance with an aspect of the present invention.

FIG. 7 is a diagram illustrating a STOW Greeting Module of FIG. 6 in accordance with an aspect of the present invention.

FIG. 8 is a diagram illustrating a STOW Teaching Module of FIG. 6 in accordance with an aspect of the present invention.

FIG. 9 is a diagram illustrating a STOW Tutoring Module of FIG. 6 in accordance with an aspect of the present invention.

FIG. 10 is a diagram illustrating a STOW Assessment Module of FIG. 6 in accordance with an aspect of the present invention.

FIGS. 11A-11B together is a diagram illustrating a STOW Feedback Module of FIG. 6 in accordance with an aspect of the present invention.

FIG. 12 is a diagram illustrating a STOW Farewell Module of FIG. 6 in accordance with an aspect of the present invention.

### DETAILED DESCRIPTION OF THE INVENTION

The preferred embodiment of the present invention incorporates existing Al technologies embodying the invention disclosed in the above-referenced Imp Character patent, including the Imp Character. For the sake of brevity, the Imp Characters are not further described herein. Readers are referred to the Imp Character patent for detailed teachings. The present invention also relates to the teachings disclosed in the following articles, both of which are hereby incorporated herein by reference: “Web Guides,” Barbara Hayes-Roth, Robert van Gent, Rembert Reynolds, M. Vaughan Johnson, and Keith Wescourt, IEEE Intelligent Systems, vol. 14, no. 2, March-April, 1999; and “Smart Interactive Characters” Barbara Hayes-Roth, Web Techniques, September, 1999. However, it will be apparent to one skilled in the art that alternative Al technologies, providing similar functionality through alternative methods, could be substituted for the Imp Character technologies in an alternative embodiment of the present invention.

The present invention improves existing technologies and teachings by providing software system and tools that give the Imp Character customizable expertise. This approach differs from prior art approaches in that it focuses on application-independent forms of expertise enabling an agent to achieve certain categories of interaction objectives, along with means of providing application-specific information enabling the agent to apply its expertise in a particular application. The invention provides a powerful approach to partitioning expertise into application-independent and application-specific components and an efficient and easy-to-use approach to specifying and incorporating application-specific information. Moreover, these methods apply across the spectrum of agent capabilities and expertise, including for example, agents that have sophisticated capabilities for mixed-initiative natural language conversation, agents whose expertise guides complex interactive logic during multiple or extended interactions with users, and agents that interact with users in characteristically human ways by displaying personalities, expressing empathy, building a social bond, etc. These capabilities enable a uniquely practical, effective, and profitable approach to creating a great variety of expert agents for deployment in a great variety of applications. In an exemplary embodiment, a computer-based expert sales agent would combine application-independent sales expertise with application-specific sales information to provide services typical of a human sales representative.

The expert sales agent would communicate with the customer in natural language dialogue. This dialogue may be exchanged via various interface input/output (I/O) technologies, including but not limited to text, speech/voice/audio, and graphics/images modalities.

The dialogue may be mixed-initiative, i.e., either the customer or the expert agent may spontaneously initiate a specific dialogue topic at any time. For example, at various times in the interaction, the agent might initiate a topic by offering a comment or question such as: “May I help you?” “Are you finding everything you need?” “Would you like me to hold that for you?” “I would love to show you anotherproduct-name.” “We have a new product-name that I think you would like.” In each of these cases, each line of dialogue and control of when to deliver it are application-independent, but certain variables (e.g., product-name) are application-specific information to be specified at development time for insertion into particular lines of dialogue for delivery during particular run-time interactions. Conversely, the customer may initiate a topic by requesting or particular types of assistance or commenting on a product or a desire. For example, the customer might ask, “what do you have on sale today?” The expert agent could respond by helping the customer to find and learn about on sale products. This may be accomplished by different application-independent methods supplemented by application-specific information, including but not limited to the following: providing the requested information directly based on application-specific information encoded in the agent's knowledge base; translating the customer's request into an effective query to the application-specific search engine; translating the customer's request into an effective query to the application-specific product database; or using application-independent expertise to guide the customer through a series of questions or choices incorporating application-specific information to identify or specify a product of interest.

The expert sales agent's dialogue may be authored in different natural languages (e.g., English, Spanish, French, Italian, Japanese, Chinese). In fact, the dialogue may be authored in multiple languages and the agent's expertise may include conversing in the user's preferred language.

The expert agent also provides the customer a variety of services typical of a human customer service representative. For example, the expert agent can provide immediate answers to the customer's questions. This may be accomplished by different methods, including but not limited to the following: providing direct answers to particular questions based on knowledge encoded in the agent's knowledge base; “pushing” information to the customer by navigating to particular site locations or retrieving information from a database or other external knowledge sources. Again, each of these services combines application-independent methods (e.g., responding to certain types of questions by navigating to an appropriate location) with application-specific information (e.g., specification of the relationships between particular questions and locations).

In this example, the expert agent also proactively encourages the customer to make purchases, explore/browse products, and/or complete a transaction by finding appropriate opportunities to communicate encouraging messages to the customer. For example, after finding a desired product for a shopper, it might ask the customer, “Would you like to put that item in your shopping cart?” Or, after the customer has found several products, it might suggest, “I would be happy to help you complete your purchase.” Or, if a customer hesitates to buy, it might remark, “You know we have a no-cost return policy, so there is no risk in buying.” Again the agent uses application-independent expertise to determine which messages to deliver and when to deliver them during a particular interaction with a particular customer. But it may instantiate or elaborate particular messages with application-specific information.

The expert agent, much like its human counterpart, learns about a customer's interaction style and preferences through observation and conversation. It then personalizes its services accordingly. For example, a sales agent might learn from observation that a first customer prefers to consider several alternative product choices before making a purchase, while a second customer prefers to consider only the “best” available product choice. Based on that observation, the sales agent proactively offers several alternatives to the first customer and only the “best” ones to the second customer. Another example, during a visit a customer tells the sales agent, “I love high-heeled pumps.” Based on that information, the sales agent greets the customer during a subsequent visit and immediately informs her, “We just got in some great high-heeled pumps from Designer-D. Would you like to see them?” As a third example, a customer tells the sales agent, “Don't keep telling me to buy.” Based on that message/instruction, the sales agent remembers and avoids encouraging this particular customer to buy.

This learning process may also be proactive. For example, the expert agent may initiate questions to a customer, e.g., “Do you prefer to get the latest styles as soon as they are out?” Alternatively, it notices and records the customer's spontaneous remarks, e.g., “I only buy things that are on sale.” Or, it observes that the customer's shopping habit, e.g., the customer always puts the most or least expensive product choice in the shopping cart.

In the sales/customer service example, the expert agent builds a continuing service relationship with the customer. The expert agent remembers what purchases the customer has made on a previous visit and follows up with questions like, “Has the blouse you ordered last week arrived yet?” Or, the expert agent combines its knowledge of customer preferences and earlier purchases to make suggestions like, “Designer-D has brought out a pair of your favorite pumps in a new lilac color. They would look great with that Designer-J dress you bought last April.”

As illustrated with the earlier types of services, the expert sales agent performs its learning, adaptation, personalization, and relationship-building services by instantiatng, elaborating, or refining application-independent dialogue and behavior with application-specific information.

The customizable expert agents of the present invention, each with its distinctive personality, mood, manner of interaction, and other life-like qualities, such as normal variability, idiosyncrasies, and irregularities in behavior, also can offer humanized interactions. For example, a sales agent might really love high fashion and entertain a customer with her opinions about different designers and anecdotes about her own fashion successes and failures. These interactions can be personalized to the customer's preferences. For example, an agent might accommodate a customer's request to “Tell me more about your boyfriend.” Or, the agent might proactively volunteer more “personal” information to a customer who asks a lot of personal questions. Moreover, these interactions can be customized with application-specific information, for example by giving the agent personal tastes or stories that relate to the products or services being offered in the application.

Although the embodiment above teaches a customizable expert sales agent for a class of retail clothing applications, the customizable expert agent can be realized for many other forms of expertise and classes of applications, including, but not limited to the following: expert sales agents for autos, real estate, computers, consumer products and electronics; expert coaches for soft skills, hard skills, athletic skills, game skills, management skills, sales skills, customer service skills, team skills, negotiation, ethics, parenting, peer interactions, partner interactions; expert tutors for a variety of subject matter; expert agents for advising, influencing, interviewing, persuading, or learning about users; expert agents for entertaining or role playing with users.

The customizable expert agent can be particularly useful to business entities that need to provide online training (hereinafter referred to as “Target Customers”). In a preferred embodiment, an Expert Coach provides application-independent coaching expertise for helping users to acquire behaviors or skills. Like the expert sales agent described above, the Coach's expertise can be customized with application-specific information for use in a particular application, potentially including parameter value specifications, dialogue, actions, flow of control logic, etc. In addition, the Coach may have expertise involving the use of learning content objects (hereinafter referred to as “Learning Objects”), which may be authored by training application content authors or acquired from a third party, and provided along with related application-specific information for use by the Coach. The preferred embodiment of the Coach and the associated preferred authoring tool are described herein in detail in a later section.

An objective of the preferred embodiment of the present invention is to create an integrated software system as well as program products for Target Customers' online training application authoring and corresponding web deployment. Specifically, an application shell presents (unlimited) online learning contents to a learner/student/trainee through a web browser interface. The web browser displays appropriate existing Learning Objects as specified by the application content author. The system mediates the student's interaction with Learning Objects via an expert agent acting as a Coach. The Coach interacts with the student in a mixed-initiative conversation and human-like manner. It tracks and evaluates an individual student's performance, provides personalized feedback, and recommends learning objects for study to remedy the student's weaknesses. Overall, the Coach guides each student along an individually optimized path to mastery of the learning goals specified by the application author. In each case, the Coach's application-independent expertise may include decision criteria for recommending a next learning object to the user, along with dialogue for introducing, explaining, or concluding the user's interaction with a type of learning object, alternative dialogue to use in various special circumstances, such as first time vs. repeat with a learning object, first error versus repeat error on a learning goal, fast learner versus slow learner, etc., and personalization of dialogue for warmth and motivation. Complementary application-specific information may be provided to identify learning objects to be used in various circumstances and to provide dialogue for use with particular learning objects or in particular circumstances. For example, for a slow learner making a second error on a particular learning objective, the Coach might deliver the following dialogue instantiating application-independent dialogue with application-specific information (in italics): “You got one out of two communication goals, John. You told Nina that the problem was late reports. But you forgot to tell her that the consequence was that she could lose her job. Knowing the consequence will help motivate Nina to improve her performance. You missed this one last time too, John. But not to worry! You've only had two tries and most people take three ties to get this right. Here is a tip: Next time, try to the tell Nina the consequences immediately after you tell her the problem.”

By delivering an application shell that references multiple Learning Objects and customizing the Expert Coach to provide appropriate application-specific commentary, personalized feedback, and proactive coaching on those objects, the present invention advantageously provides an engaging, efficient, and effective online learning experience for users. This represents a significant improvement over online learning approaches typical of the industry, in which users find a self-service environment of “pages on the web,” in some cases augmented with self-service access to advice or, rarely, communication channel to a human teacher. It also represents a significant improvement over human instructors, where economic, logistical, and psychological constraints limit access, time, and quality of services for individual learners.

With the preferred authoring tool, the present invention has the additional advantage of being easily, efficiently, and economically customizable for creating new applications or for modifying existing applications, requiring very little technical skill and relatively little time on the part of the application authors. Specifically, the preferred authoring tool enables creation and maintenance of Expert Coach applications by instructional designers or subject matter experts, with little or no need for programming services. In addition, the resulting Expert Coach application is scalable to provide individualized coaching services to any number of users (with support from an appropriate number of CPUs running the server-side software engine).

A specific embodiment of the present invention will now be described in which the expert agent is a coach (Expert Coach) having general (function/category) expertise in coaching and application-specific (sub-function/sub-category) expertise in coaching “people skills.” That is, skills for interacting effectively with other people.

The Skills Training Online Workshop (Stow) Embodiment

In this embodiment, an Expert Coach offers proactive instructions and feedback related to application-specific learning goals and learning objects, as well as individualized coaching and interstitial dialogues for motivating, interviewing, or otherwise communicating with a user.

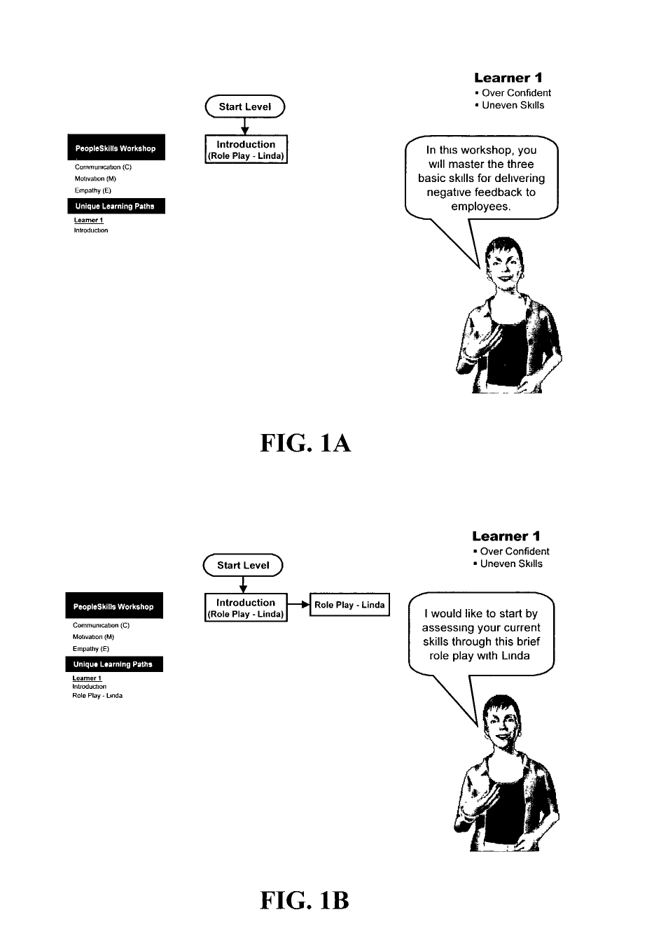

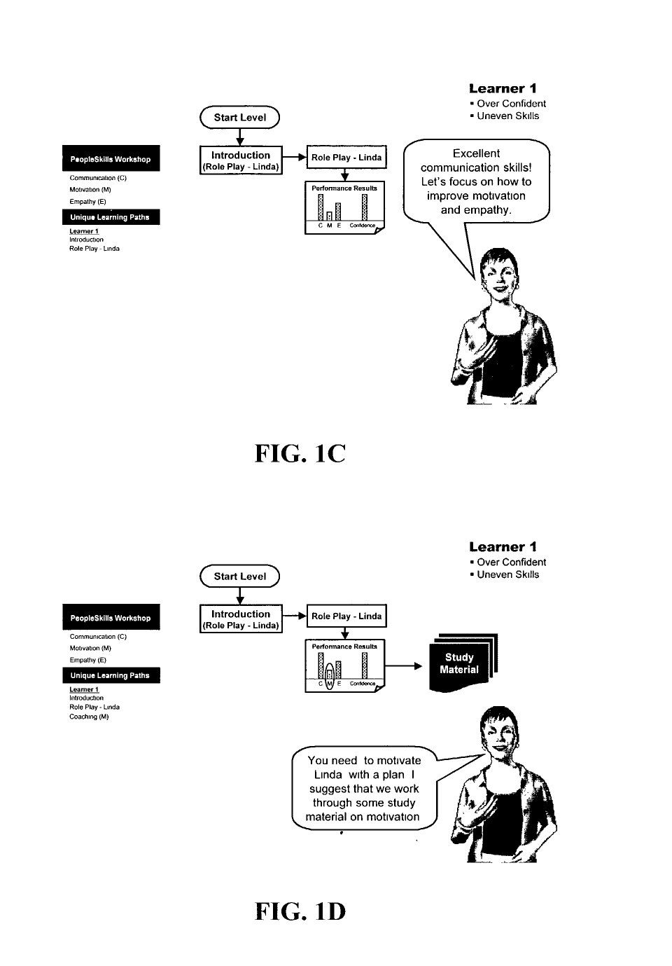

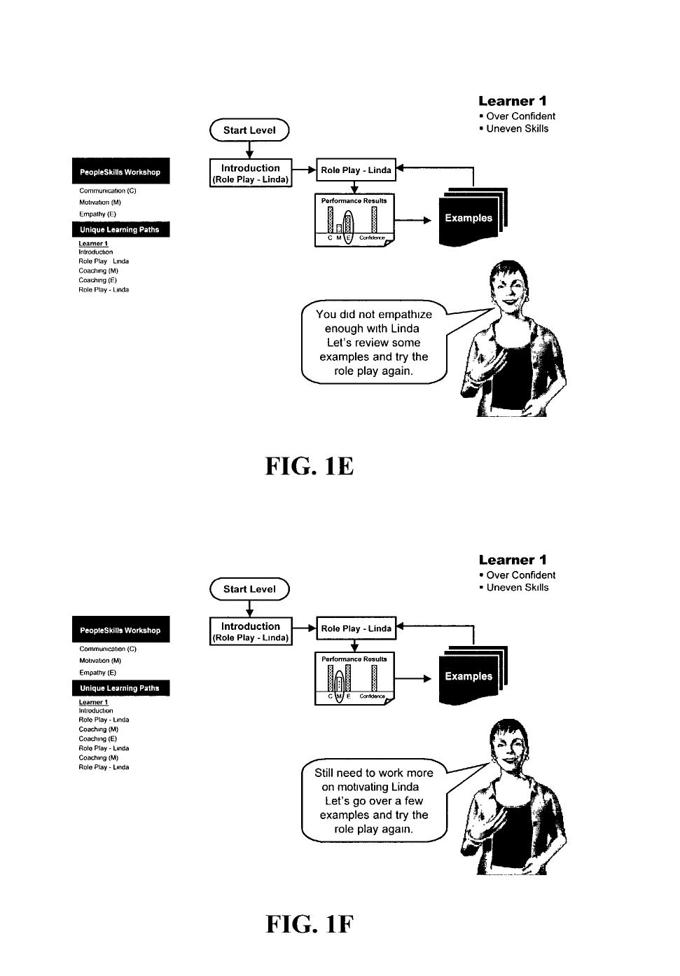

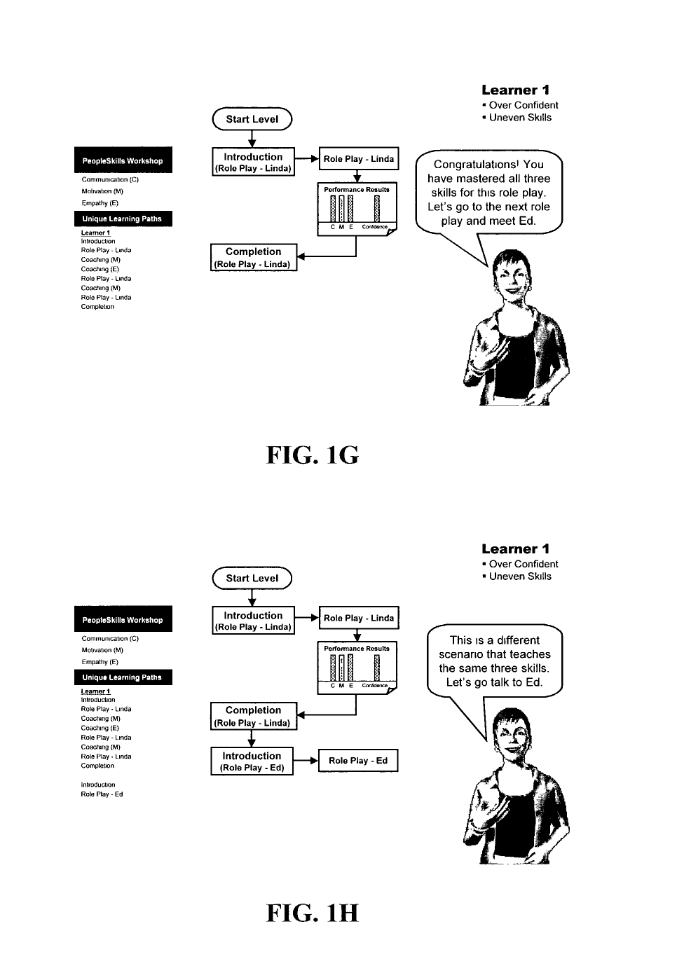

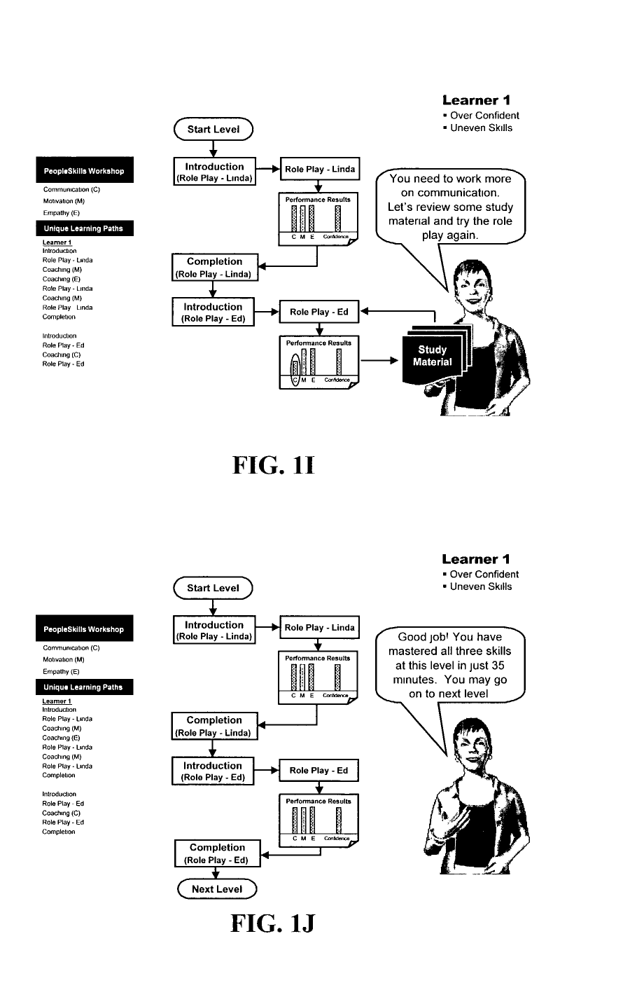

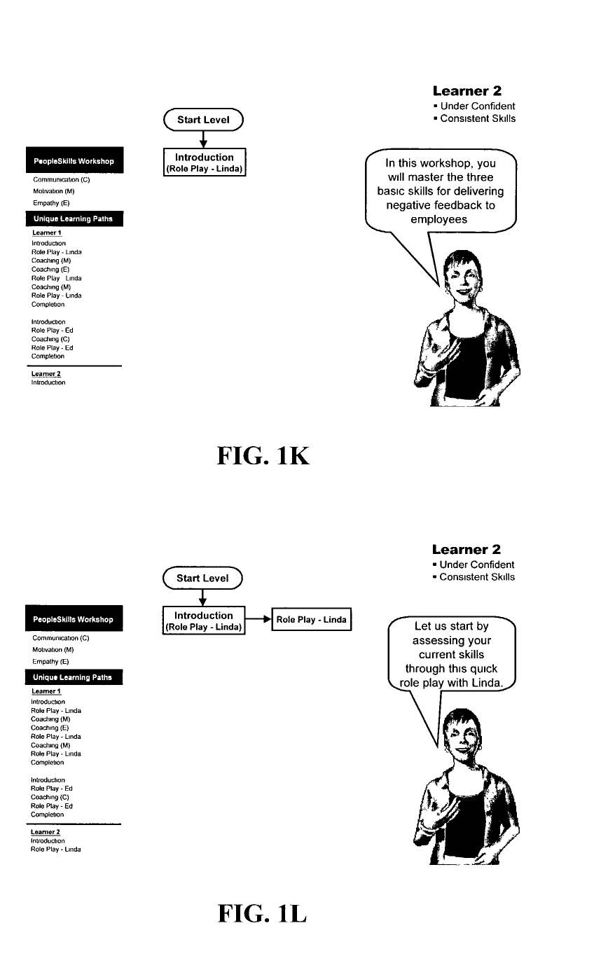

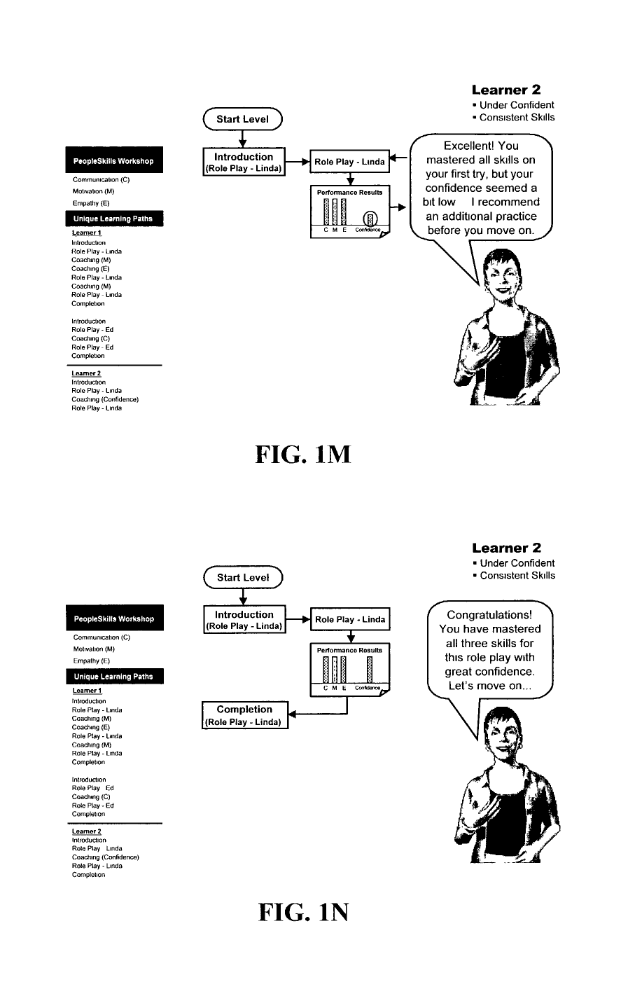

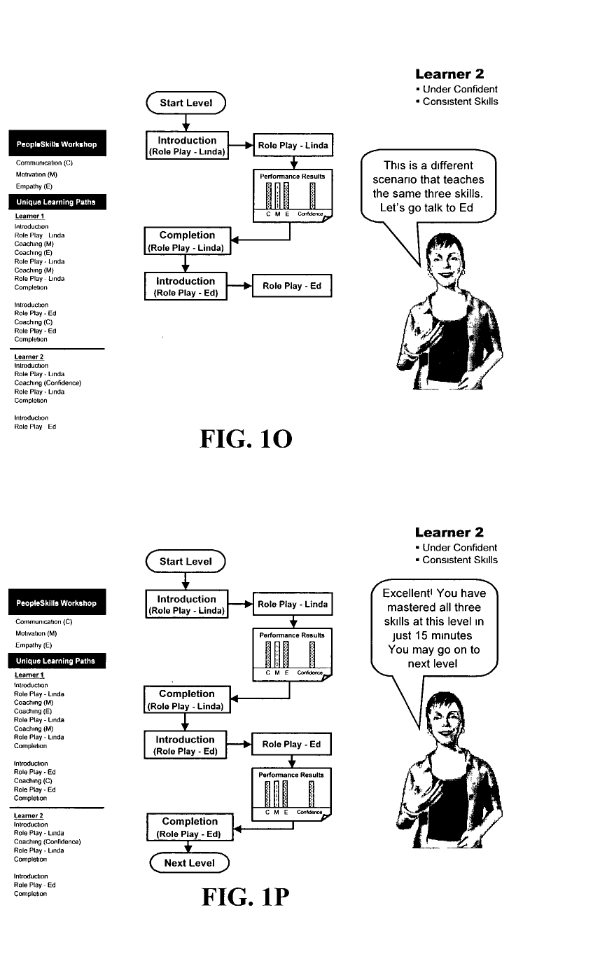

Referring to FIGS. 1A-1P, the Expert Coach, appearing as a female digital character, offers proactive instructions and feedback, as well as individualized coaching related to “people skills” to two different human users. FIGS. 1A-1P together demonstrates how a current embodiment of an Expert Coach guides, motivates, and reinforces learning, while individualizing and optimizing the learning path, for each of the two human users: one who is over-confident and has uneven initial skills (Learner 1), and one who is under-confident and has consistent initial skills (Learner 2).

The Expert Coach displays application-independent coaching expertise in her pedagogical strategy: provide the user an overview of target skills, assess the user's current skills in a role play, give the user feedback on performance of component skills in the role play, tutor the user on weak skills identified in the role play, repeat the assessment-feedback-tutoring loop until all skills are perfect in role play, repeat the assessment-feedback-coaching loop on a second role play until all skills are perfect in that role play. The Expert Coach also displays application-independent content in some of her motivational dialogue, for example, “Excellent! You mastered all skills on your first try.” The Expert Coach displays application-specific content in her use of particular learning objects, such as the “Introduction,” “Examples,” and “Study Material” objects. She uses application-specific learning objects for the “Linda” and “Ed” role play objects. She also uses application-specific dialogue, for example, “You need to work more on Communication.”

The functionality demonstrated in this embodiment is implemented in a generalizable form where the number of learning objects presented is unlimited. The present embodiment adopts and implements the following:

1. Definitions and Terminologies

AICC Aviation Industry CBT Committee (AICC)

API application programming interface

Application a specific and named configuration of collected and authored content managed by a coach authoring tool (CAT) and uploadable to a STOW Content Database for execution by a coach application shell (CAS)

Assessment Object a type of Learning Object that generates data on a learner's performance

Author an Application author; a user of CAT

Autonomous Dialog sets of dialogue made up of (possibly parameterized) text to be delivered by the Coach under particular conditions that is dynamically generated at runtime using content and algorithms in CAS. This content is not generated or altered by an Author, but may contain parameters whose values are specified by an Author

CBT Computer-Based Training

Coach an Extempo agent (Imp Character) designed to run within CAS

Coaching an instructional method in which an instructor provides access to learning-related activities interspersed with commentary that guides, evaluates, and motivates a learner via one-on-one interactions

Coaching Template a type of Dialogue Template

Curriculum a set of relationships defined among all objects in an on-line

Information Network instructional system

(CIN)

[DESIRED] a tag used herein to identify a desirable but not required design feature

Dialog a component containing text content to be output (“spoken”) by the Coach, which may be Autonomous (generated from content built into CAS) or Authored (in CAT) or a combination of these. Authored Dialogue is composed from Dialogue Templates

Dialogue Template a representation of parameterized text authored in CAT and used by CAS to generate personalized coaching commentary

Feedback Dialog a type of Dialogue intended for Coach output immediately following a learner interaction with an Assessment Object

Feedback Template a type of Dialogue Template

Instruction Dialog a type of dialogue intended for Coach output in any instruction context

Instruction Object a type of Learning Object

Learner an end user of a Coach application executing in CAS

Learner Object an externally authored and managed unit of instructional content which supports an interface enabling a training application to present/execute it and possibly returning learner performance data

Learner Preference a set of preferences obtained from the learner regarding presentation and coaching.

Learner Profile a database containing information about all significant learning

Database (LPD) events experienced by each learner of a STOW application. There is one LPD per application.

LMS Learning Management System

Master Database there is one Master Database for each STOW installation. The Master Database contains User IDs and passwords as well as application independent information that STOW has gathered about learners, such as learning style and preferences, thus a repository for general user (Learner) profiles

Metadata properties of any object in a CIN whose values are used to control the internal processing of CAT or CAS as opposed to values used in content presented to learners

[REQUIRED] a tag used herein to identify a mandatory design feature

SCORM Sharable Content Reference Model; SCORM Specification Documents incorporated herein by reference include:

The SCORM Overview, version 1.2, Oct. 1, 2001;

The SCORM Content Aggregation Model, version 1.2, Oct. 1, 2001;

The SCORM Run-Time Environment, version 1.2, Oct. 1, 2001;

The SCORM Addendums, version 2.0, Jan, 4, 2002; and

SCORM Conformance Test Suite Version 1.2, 15 February 2002

STOW CAS Skills Training On-line Workshop Coach Application Shell; the computer program(s) which execute applications authored with STOW CAT

STOW CAT Skills Training On-line Workshop Coach Authoring Tool; the computer program for creating Coaching applications described herein

STOW CAT CD Skills Training On-line Workshop CAT Content Database; the authoring time database used for persistent storage by CAT

STOW CD Skills Training On-line Workshop Content Database (also SCD); the run-time database used by CAS which includes data uploaded from CAT

STOW Upload Skills Training On-line Workshop Upload; a utility program for uploading an SCD to a CAS server

Teaching Goal an abstract representation of a knowledge or skill acquisition objective addressed by an application

Teaching Goal Agenda an ordered list of Teaching Goals defining a desired sequence in

(TGA) which they are to be achieved by learners over the course of using an application

Teaching Script a sequence of Teaching Script Modules intended to promote or test achievement of one or more Teaching Goals

Teaching Script Module a pre-defined pattern of Learning Objects and Dialogue Templates

(TSM) instantiated as a component of a Teaching Script

Teaching Strategy a sequence of Learning Objects and Dialogue Templates intended to cause achievement of one or more Teaching Goals

2. Requirements

2.1. STOW CAS and STOW CAT

The STOW CAS delivers externally created Learning Objects that conform to the STOW runtime API in a sequence defined using the STOW CAT. The STOW CAT enables authoring of all application-specific Coach content for STOW CAS applications. The Learning Objects are to be sequenced and accompanied by Coaching Dialogue in a manner that has been authored in the STOW CAT.

2.2. Extempo AI (Imp Character) Technologies and Products

The STOW embodiment incorporates several existing Extempo products, including:

1. The Imp Engine version 2. 1;

2. The Extempo ISAPI client, as needed;

3. One or more Extempo Java clients, as needed, and possibly the Imp Talk client; and

4. A compiled Imp character knowledge file containing the content-independent logic of the CAS.

Coach content created in STOW CAT is executed in STOW CAS using the latest versions of the Extempo Web Guide product and the Extempo Imp Server. No modifications to prerequisite Extempo technologies and products are required beyond any required by STOW CAS. Moreover, the following points will be apparent to one skilled in the art: (a) content similar to content created in STOW CAT could potentially be created using other sorts of tools and user interface approaches, some of which might be quite different in look, feel, function, and underlying technology from STOW CAT; and (b) content created by STOW CAT or similar content created by an alternative tool could be run using an alternative run-time technology providing similar functionality, but otherwise different, even substantially different, from the Extempo Imp Server.

2.3. Usability

The primary user group for a STOW Application comprises people who interact with the application in order to learn skills taught by the application. The present embodiment includes a simple, easy to navigate user interface that allows Learners to focus on learning activities, including their interactions with the Coach, without unnecessary distraction. The user interface for STOW may optionally be designed to include software plug-ins, for example to provide animation or voice for the Coach or to enable certain types of learning objects in a particular application. However, it is also possible to create STOW applications with simple user interfaces requiring no additional plug-ins or software installation on the client platform.

Generally, STOW CAT provides the look-and-feel and overall usability features of popular commercial tools for content authoring, e.g., Web/HTML (hypertext markup language) authoring tools, word processors, business drawing tools. Installation of STOW CAT is simple, requiring only minimal effort. After installation, Target Customers can begin to use STOW CAT with minimal training, e.g., one day training and a 20-page user manual.

2.4. Integration with Target Customers and Third-Party Technologies

Potential integrations may occur at the database level, at which conventional learner profiles for applications will be represented in STOW in standard relational database form.

Additional integrations enable STOW applications to run within a third party LMS system as an atomic content object capable of communicating results from all its own Learning Objects to the LMS using the SCORM runtime API. This would involve STOW being launched from a URL but occupying a different frameset in order to comply with SCORM standards. The launch URL would contain JavaScript mechanisms capable of communicating the results back to the LMS in its parent frame.

STOW can be integrated with and deliver existing third party Learning Objects that conform to the STOW properties specification and runtime API (see section 3.3), which can be a subset of the SCORM standard runtime API and properties specification.

STOW CAT can install and operate on personal computers and workstations commonly present and available to Authors of Target Customers.

STOW CAT can co-exist with common third party software tools and applications typically installed on the personal computers and workstations commonly present and available to Authors of Target Customers.

STOW CAT supports universal system-level application integration typical of end-user applications (e.g., cross-application “cut-copy-paste” of text, application-switching, etc).

STOW CAT utilizes storage mechanisms and accesses interfaces for persistent data consistent with system-level data backup/restore applications.

2.5. Minimum System Requirement

STOW utilizes standard client-server architecture. The minimum system required to run the STOW server-side component comprises:

Windows NT 4.0 or Windows 2000 operating system. (However, it will be apparent to one skilled in the art that the software could readily be ported to a Unix, Linus, Java, or other platform.)

Pentium-class processor

Internet/Intranet connection over which the Application is to be delivered.

Web server, e.g., SQL server, running ODBC compatible enterprise Database Management System

128 MB RAM

At least 50 MB free hard disk space

The minimum system required on the client side (Learner's system) comprises:

Windows, Macintosh, Unix or Linux operating system.

Web browser, e.g., Netscape 4+, IE 4+or AOL 4+.

Internet/Intranet connection over which the Application is to be delivered.

STOW CAT can install and perform acceptably on a Pentium III class system with 600 MHz processor, 128 MB RAM, at least 100 MB free hard drive space, TCP/IP-capable network connection and Windows 2000/XP operating system. Because it is written in Java, STOW CAT also can install and perform acceptably on most Unix and Linux platforms.

2.6. Performance

STOW applications provide Coach dialogue and local content objects to Learners at a reasonable speed (within 4 seconds) for client-server connection speeds >56K and within a reasonable connection latency for servers and clients that meet or exceed the minimum system specification given in section 2.5. Delivery of remote content objects is dependent on external network infrastructure. STOW CAT starts, operates interactively, and closes down without noticeable delays or pauses slower than competitive commercial content authoring tools; e.g., Web/HTML authoring tools, word processors, business drawing tools.

2.7. Reliability

The STOW CAS delivers applications with a reasonable level of reliability and is available whenever the server is online. High priority areas of risk avoided include loss of Application content data and loss of learner profile data, client failure, and learner session termination. A range of client implementations for different client system configurations is offered to minimize the risk of client failure. Database transaction logging is used to allow rollback in the event of errors or server crashes.

STOW CAT can operate as stably (in terms of frequency of crashes) as other successful commercial tools for content authoring that are familiar to Target Customers; e.g., Web/HTML authoring tools, word processors, business drawing tools. In the event of a crash, loss of customer-entered data is limited to the current “session”. In the event of a crash, loss of customer-entered data is limited to a few minutes of customer work.

2.8. Standards Compliance

The STOW Application shell complies with the emerging Sharable Content Object Reference Model (SCORM™) standard. SCORM defines a web-based learning “Content Aggregation Model” and “Run-time Environment” for learning objects.

The Content Aggregation Model contains guidance for identifying and aggregating resources into structured learning content. SCORM Content Object metadata is attached to Learning Objects in the form of XML documents complying with a standard model. The STOW CAT allows Application Authors to annotate the Learning Objects for an Application with additional consistent sets of metadata for the Learners.

The Run-time Environment includes guidance for launching, communicating with and tracking content in a web-based environment. This includes a common Launch and standard API (e.g., JDBC. ODBC) specification, and the AICC Data Model for web-based data elements. The STOW embodiment implements a subset of the Launch and API specifications and the Data Model. STOW CAT uses standard API for database calls to any relational database it uses for its own storage purposes or it accesses for external data.

STOW CAT is implemented using products and technologies that are defacto or de jure standards for general software development and for training-related applications, including interfaces for accessing descriptions of Learning Objects that conform to the SCORM specification for Web-based instructional content.

3. STOW CAS Specifications

3.1. Architecture

3.1.1. General

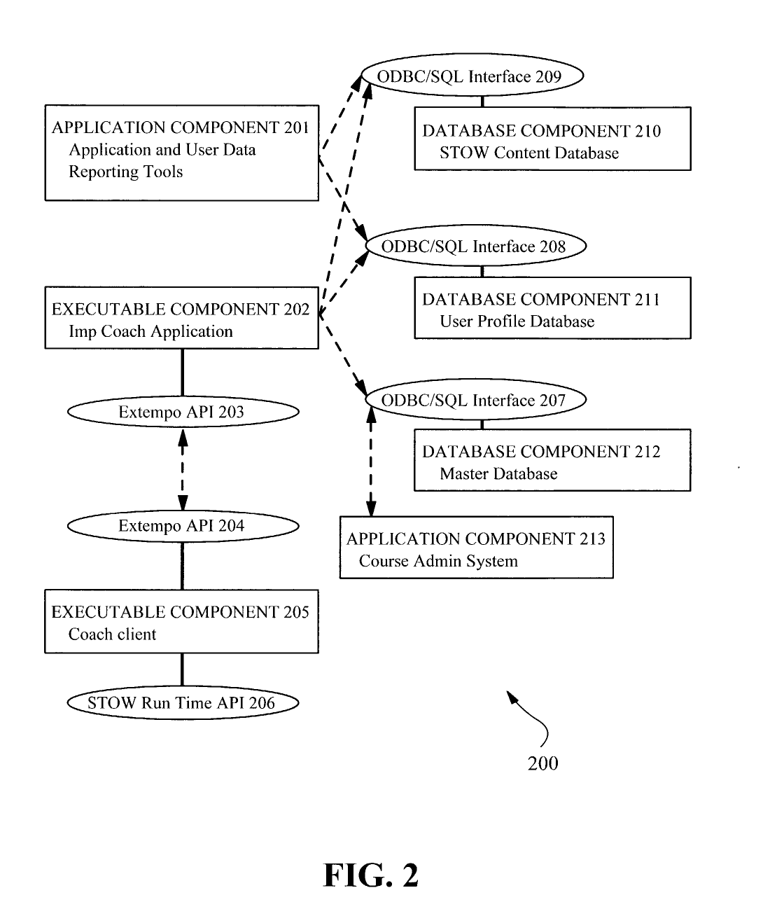

Referring to FIG. 2, in a preferred embodiment of the present invention, the STOW CAS 200 comprises a plurality of Application components, executable components and interface components, including:

1. A simple administration system allowing Learners to register and log in to applications, such as Course Admin System 213.

2. A new Imp Coach Application created in the form of a compiled Extempo Imp file, such as Imp Coach Application 202.

3. A generic SCORM conformant Learning Object Runtime Interface component, such as STOW Run Time API 206.

4. A STOW Master Database, such as STOW Master Database 212.

5. One or more STOW Content Databases with attached Stored Procedures, such as STOW Content Database 210.

6. One or more STOW Learner Profile Databases, such as STOW User Profile Database 211.

7. One or more Coach agent clients, such as Coach client 205.

8. Application and Learner data reporting tools, such as Application and User Data Reporting Tools 201.

In the present embodiment, the runtime environment comprises an Imp Engine running on an Internet connected Windows NT or 2000 server linked, via interfaces 207-209, to server databases for the Coach dialog, learning object link and meta-data, and end user profiling and progress data. However, it will be apparent to one skilled in the art that the software could readily be ported to a Unix, Linus, Java, or other platform.

An Internet connected web server in the same domain responds, via interfaces such as Extempo API 203-204, to requests for browser interface web pages, client side code components, STOW provided art and media elements, and any locally stored SCO learning objects.

3.1.2. Data Input Sources

Data enter into the Application shell from the following sources:

1) A complete STOW Content Database (and associated Learner Profile Database) created by an Application Author using the STOW CAT and published to the server using the STOW Upload Skills Tool. This publishing uses a database-independent API.

2) Data relating to Learners from the Learner Profile Database and Master Database.

3) Information entered by Learners during registration for applications (User IDs, passwords and system nicknames—see Section 3.22).

4) STOW API-compliant communication from Learning Objects.

5) Button selections or free text inputs made by the Learner.

3.1.3. Data Representation

The chief data representation resides in databases through standard data types supported by any commercial databases for persistent storage. Data are persistently represented in a STOW installation by one Master Database and a STOW Content Database and Learner Profile Database for each Application that has been published to the installation.

3.1.4. Data Storage

Each installation of STOW should have a Master Database in the Database Management System that lists the names of the applications that are available, whether they are open or closed registration and what the name/index number of each database associated with each Application is. A record is to be added to this database every time an Application is published. This database will also contain application-independent “Global Learner Profiles,” containing persistent general information about Learners such as their preferred ‘nicknames’ in the system, their preferences for certain forms of interaction, their individual learning styles, their learning histories and accomplishments, etc. These pieces of information are used to determine Coach behavior for the Learner over all the applications available in the STOW installation.

Because the Global Learner Profiles are expandable this table of the Master Database is implemented as a property value list like that currently used for Extempo's standard user profile databases. The STOW Coach (customizable expert agent) has both read and write permissions to this database. As such, the Coach is able to add new property elements that can be attributed to users and new values for those properties as desired.

Application data are to be stored in STOW in an authored STOW Content Database. The Application Author will create this database using the STOW Course Authoring Tool. There is a one-to-one mapping between applications available on an installation of STOW and STOW Content Databases. The contents of a STOW Content Database are not written to at runtime and can only be changed by republishing the application. The present STOW coach does not have write permissions on this database. However, it will be apparent to one skilled in the art that a more sophisticated STOW Coach might learn something in the course of its coaching activities with one Learner that applies to its interactions with many Learners; given writer permissions on the Content Database, the Coach might then “author itself” by modifying elements in the appropriate Content Database.

A Learner Profile Database for an Application is read and written to at runtime and contains a record of every significant learning event that occurs for each Learner that logs in to the application. The Coach will write to this database in response to communications from learning objects and the Coaches' own internal triggers. Suggested entities to be modeled in this database are Learners (by User ID and password), Learner-associated events (e.g assessments with associated scores), and book-marking of position in a learning unit or course. Some of these entities are application-independent and built into the Coach, while others are application-specific and may be authored by an author. The STOW coach will have write permissions on this database allowing it to update the information on-the-fly at runtime.

A one-to-one mapping between available applications and Learner Profile Databases is also to be provided.

3.1.5. Data Output

STOW will deliver output to the Learner by launching learning objects, through dialogue spoken, typed, or otherwise displayed by the Coach, and through other gestures or actions displayed or performed by the Coach. Each STOW installation should have a few application-independent pages to serve as a front end/minimal administration system.

3.2. Functionality

3.2.1. Application Delivery

The delivery of an Application in STOW comprises the launching of local or remote Learning Objects in a sequence defined by the Application Author using the STOW CAT and the Coach's delivery of associated application-independent and application-specific dialogue. At runtime this sequencing is created by the iteration of an abstract Application delivery logic contained in the Extempo Imp Coach file over the contents of a STOW Content Database, Learner Profile Database and installation Master Database. The abstract Imp Coach structure will contain modules for distinct coaching functions such as introduction of a Teaching Goal, introduction of a Learning Object, feedback on an Assessment Object and coaching on an Assessment Object. Five general mechanisms are involved in Application delivery.

1) The Imp Coach will iterate over an abstract structure that involves database calls to the STOW Content Database and Learner Profile Database for the application. These calls will determine the current status, e.g. the first incomplete Teaching Goal for the Learner and the Teaching Script associated with that object. The Teaching Script will determine which modules of the abstract logic are activated and in which order.

2) The abstract course delivery logic will contain Autonomous Dialogue elements for the application-independent dialogue involved in introducing (greeting) elements, giving feedback and coaching. These are to be instantiated at runtime with the names of teaching goals, learning objects and Learners and delivered by the Coach. This will produce coaching content that is personalized to the particular situation and learning history of the Learner. Information about application-independent Learner characteristics that have been observed by the Coach will be stored in the Master Database and will determine the nature of the Autonomous Dialogue given by the Coach along with state and context information internal to the Imp Coach and in the SCD and LPD.

3) Application-specific dialogue lines are to be retrieved from the STOW Content Database through database calls authored at the relevant points within the abstract modules of the Imp Coach structure. The Coach will then deliver them. This will produce coaching content that is application-specific.

4) Learning objects can be launched using URLs stored in the STOW Content Database. They will then communicate with the Coach using the API defined herein.

5) Assessment Objects will communicate information about Teaching Goal attainment to the Coach. The Coach will store this information in the Learner Profile Database. The information may then be used in conjunction with the STOW Content Database to determine the future sequencing of learning objects and the content of personalized coaching.

3.2.1.1. Pedagogical Model

The STOW Application shell implements an effective pedagogical strategy that controls the sequencing of learning objects at a fine-grained level. This dictates that each Teaching Goal implemented in an Application will include the delivery of one or more Teaching Script Modules. There are 3 types of module:

1) Instructional Module—contains instructional dialog, Instruction object, and instructional dialog.

2) Assessment Module—contains instructional dialog, Assessment Object, and feedback dialog.

3) Simple Instruction Module—contains instructional dialog.

These modules will be accompanied at run time by application-independent dialogue implemented in the STOW CAS, along with application-specific dialogue and authored in the STOW CAT. They will be sequenced at run time by sequencing instructions authored in the STOW CAT.

3.2.1.2. Autonomous (Application-Independent) Dialogue

The Coach can be implemented with different sets of parameterized Autonomous Dialogue which can contain application-independent content (coaching, motivation, etc.), possibly augmented with application-specific dialogue, and be instantiated and delivered contingently at runtime. This dialogue is used to give runtime information, guide the Learner, offer appropriate encouragement, find out global user preferences or learning styles, etc. The following exemplifies how such dialogue can be delivered, with application-specific dialogue in italics.

1) Situation: Start of Learner's session with a STOW application.

Dialogue Determiner(s): New Learner/ length of time since last session (<1, 2-7, or >7 days)

Sample Dialog: “Hola Joan, welcome back to Spanish for Au Pairs!”

“Buenos dias, Joan, it's nice to see you again.”

“Hi Joan, it's been a long time—I missed you!”

2) Situation: Feedback Dialogue after a Learner has attempted an Assessment Object, before detailed Autonomous Dialogue describing scores is given.

Dialogue Determiner(s): Previous replies to this question

Sample Dialog: “I'd like to review your correct performance, as well as your errors, OK?”

“I guess you don't like me to give feedback on your correct performance, so I'll just review your errors for the rest of the session, OK?”

Side Effects: Write preference to Master Database.

Store preference in Imp for use in rest of the session.

3) Situation: Feedback Dialogue after a Learner has attempted an Assessment Object.

Dialogue Determiner(s): Current scores on Assessment Object

Previous scores on Assessment Object

Sample Dialog: “That was a great effort, much better than last time! You scored 4 on the Advanced Router Maintenance simulation.”

4) Situation: End of Feedback Dialogue after an Assessment Object

Dialogue Determiner(s): Performance

Sample Dialog: “I guess you are feeling pretty confident right now. Am I right?”

Side Effects: Follow up Autonomous Dialogue (see below)

Store emotional state in Imp for duration of session.

5) Situation: Follow up dialogue delivered after Autonomous Dialogue described above.

Dialogue Determiner(s): User response to Dialogue above.

Sample Dialog: “That's great! Congratulations!”

6) Situation: Dialogue delivered when a Learner commences the Teaching Script for a Teaching Goal that they have already tried at least once.

Dialogue Determiner(s): Application Author decision

Number of times the Learner has tried the Teaching Script

Sample Dialog: “I know this must be frustrating for you, Joan, but I know you are going to do better this time. In fact, you are still ahead of the average 5 tries required by most people.”

7) Situation: Dialogue delivered at end of Feedback Template before Authored Dialogue with motivational content

Dialogue Determiner(s): Master Database preference entry.

Previous user responses.

Sample Dialog: “I'd like to coach you on the goals you missed-situation and consequences. OK?”

“You don't seem to like me coaching you, but I really think it would help you. May I give you a little coaching this time?”

Side Effects: Follow up Autonomous Dialog

Storage of preference within Imp for duration of session.

Entry of preference into Master Database.

8) Situation: Follow up dialogue delivered after Autonomous Dialogue described above for each goal of the Assessment Object that the Application Author has specified that they want the Coach to give Feedback Dialogue on.

Dialogue Determiner(s): Response to Autonomous Dialogue shown above.

Sample Dialog: “Now I'll coach you onempathy. This is probably the most important communication in performance feedback.”

Side Effects: Feedback Dialogue Template contents delivered or not for each goal.

Follow up Autonomous Dialog.

9) Situation: End of Feedback Dialogue Template if Coaching Dialogue has been delivered.

Sample Dialog: “We've covered a lot of ground. I'm thinking that you will do just fine this time. Do you agree?”

Side Effects: Follow up Autonomous Dialog.

Store status information in Imp for duration of session.

3.2.1.3. Algorithms

The algorithms required for the following major functions can be implemented within the Imp Coach Application using the Imp scripting language.

1) Function: Sequence and launch learning objects and deliver dialogue according to the Curriculum Information Network defined by the Application Author in the STOW CAT.

Implementation: Some large nested loop as shown in outline below and implemented as a series of “Stops” in the Imp Web Guide Role.

Do While Not (Learner selects Quit)

Find the next Teaching Goal in the agenda that has not been achieved for this Learner (DB calls to LPD, SCD)
Do While (not come to the end of the Teaching Goal)

Find the next Teaching Script Module in the Teaching Script for that Teaching Goal.
Do While (not come to the end of the Teaching Script)

Find the next element in the Teaching Script Module.
Do While (not come to the end of the Teaching Script Module)

Select (what type of element is it)

Case: Dialogue element

Call Algorithm 3

Case: Instruction object

Launch
Wait for it to send LMSLaunch() (some time out/error handling)
Wait for it to send LMS Finish() (some time out/error handling)
Write to LPD

Case: Assessment Object

Launch
Wait for it to send LMSLaunch() (some time out/error handling)
Wait for it to send scores
Wait for it to send LMS Finish() (some time out/error handling)
Write to LPD
Check Teaching Goal Evaluation Standard - if complete exit Teaching Goal

End Select

Loop

Loop

Loop

Loop

Input: STOW Content Database

Learner Profile Database

Master Database (for cross-application personalization with Learner name)

API-based communication from learning objects indicating that they have started or finished, and user score information from Assessment Objects.

Output: Instructions to Imp client to go to Learning Object launch URLs Coach dialogue sent to client

2) Function: Transform parameterized Dialogue Templates by substituting literals for any parameters contained in them.

Implementation: A generalized Stored Procedure defined on the STOW Content Database that will convert parameters into their runtime values. The Imp character will call this procedure, passing parameters that identify the piece of dialogue to be retrieved. The Stored Procedure will check the dialogue for parameters, replace them if necessary, and return a literal string to the Imp. This stored procedure will be added to the database as part of the upload process performed by the STOW Upload Skill tool.

Input: STOW Content Database—parameterized Dialogue Templates created by Application author.

Learner Profile Database.

Master Database (for cross-application personalization)

Specific items to be substituted include:

Name of current Learner

Name and description of current Teaching Goal

Name and description of next Teaching Goal

Name and description of last Instruction Object

Name and description of next Instruction Object

Names and descriptions of all Teaching Goals for the preceding Assessment Object

Name and description of the most recent Assessment Object

Pass/Fail status of Learner's achievement on each Teaching Goal defined for the preceding Assessment Object.

Output: Literal coach dialogue sent to client.

3) Function: Decide which parameterized Dialogue Templates or Autonomous Dialogue to deliver depending on the current context.

Implementation: This is to be implemented as a set of functions or single function (Stop?) in the Coach which will choose the ‘first time’ dialogue the first time any Learner arrives at this dialogue point and will alternate between the other alternatives for all subsequent times the dialogue point is reached by the Learner.

Input: STOW Content Database

Learner Profile Database

Internal agent state flags that indicate which Dialogue Templates and authored coach dialogue have previously been used

Set of alternative coach dialogues created by the Application author.

Set of parameterized Dialogue Templates

Output: Selected parameterized dialogue template to be passed to algorithm set 3 Authored Coach Dialog

4) Function: Respond to learning event triggers (e.g. getting a set of scores from an Assessment Object) by writing information to the Learner Profile Database.

Implementation: Triggers in the control flow of the Imp file that fire database calls.

Input: Typed/select input from the Learner (e.g. registration, logging on to the application)

Learning Object communication.

Output: Data inserted into Learner Progress Database

5) Function: Choose Autonomous Dialogue and replace parameterized Autonomous Dialogue in the Imp file with literal dialogue by instantiation with runtime parameters.

Implementation: Status variables set and maintained within the Imp—these variables are referenced by the Autonomous Dialogue and used to choose which Dialogue from a set of Autonomous Dialogue to deliver.

Input: (indirect) Previous interactions with the user which result in status variable values.

Learner preference information from the Master Database.

Output: Literal dialogue sent to the Imp client.

3.2.2. Application Administration

A STOW installation will present one front page that shows all the applications that are available on the STOW installation as selectable links and an indication whether these applications are open for new registrants.

If a Learner selects one of these links for a closed registration Application they are asked to supply their User ID and password and a password for the application. If it is an open registration Application there will be no password for the application.

New Learners can register with STOW by creating a username and password that is unique in the STOW installation. They will also be asked to enter a first name or ‘nickname’, by which they would like to be addressed.

When an Application is authored in the STOW Course Authoring Tool, the Author will have the option of specifying whether registration for that Application is open or closed.

If registration is to be closed, the Author will get the opportunity to enter a password for the application.

If an Application is specified as open registration, no application-specific password will be made.

The mechanism for this can be implemented as a set of HTML pages and associated ASP scripts that will write the Learner-created User IDs and passwords to the Master Database accessible from any application. This is to include a check on username/password combination completeness.

This is an interim solution to allow cross-application personalization through name use. It assumes that STOW will be providing some LMS functionality for the customer and would not be useful in a situation in which the STOW Application is in use in an enterprise that already has an LMS delivering other applications. In that situation, it would be redundant or even conflicting with the LMS.

3.2.3. Reporting

The STOW CAT includes a standardized reporting system for conveying Learner and application-centered data to an Application Author or administrator. This currently is implemented as a set of scripts and HTML pages and uses data from the Learner Profile Database and STOW Content Database to present individual and aggregate statistics and views relating to Learner-application interactions.

3.3. Data Semantics, Presentation, Properties

3.3.1. Curriculum Information

3.3.1.1. Data Source

The Data Source for all items of Curriculum Information is to be the STOW Application Content Database.

3.3.1.2. Learning Objects

3.3.1.2.1. Launch/Presentation to Learner

The STOW CAS launches Learning Objects using a URL, which is to be stored with the representation of the learning object in the STOW content database. The learning objects are then displayed to the Learner in the central frame of the browser window that is displaying STOW.

3.3.1.2.2. Properties

Teaching Goals may have additional properties defined in CAT to assist Authors in Application creation. Learning Objects should be described within CAS by at least the following properties:

LO_URL: A URL for launching the Learning Object

LO_Name: A short name for the object suitable using in Autonomous Dialogue within CAS such as “After you've completed <LO_Name>, you'll understand . . . ”

LO_Description: A short text description, possibly a short paragraph, which should describe the nature or purpose of the object, suitable for use in Autonomous Dialogue within CAS such as “<LO_Name>is <LO_Description>”.

LO_Teaching_Goals_Scoring: A list of Teaching Goal objects denoting the Teaching Goals addressed by the Learning Object; used in Autonomous Feedback Dialogue to give feedback on scores and comparisons with previous performance.

LO_Teaching_Goals_Coaching: A list of Teaching Goal objects denoting the Teaching Goals addressed by the Learning Object; used in Autonomous Feedback Dialogue to give coaching on Goals.

LO_Type: An enumerated value with the following possible values:

Instruction_Object: The object does not return performance measures on any Learner interaction with its content.

Assessment_Object: The object returns performance measures on Learner interaction with its content.

LO_Assessment_Data_URL: If LO_Type=Assessment Object, then a URL for accessing the performance data generated when a Learner interacts with the object content; otherwise, value is undefined;

LO_Dialog_Pre: A optional Dialogue of type Instruction which Authors may create to provide shared default or additive content for Dialogues that are components of Teaching Script Modules that execute the Learning Object. Use of this Dialogue will integrate with Dialogue that immediately precedes the Learning Object in a Teaching Script Module.

LO_Dialog_Post: A optional Dialogue of type Instruction if this is an Instruction Object and type Feedback if this is an Assessment Object which Authors may create to provide shared default or additive content for Dialogues that are components of Teaching Script Modules that execute the Learning Object. Use of this Dialogue will integrate with Dialogue that immediately follows the Learning Object in a Teaching Script Module.

3.3.1.2.3. Learning Object Communication

Communication between Learning Objects and the STOW CAS occurs at runtime through the STOW API which is defined in Appendix 1 using a subset of the AICC Data Model.

3.3.1.2.3.1. Instruction Object Communication

An Instruction object will only be required to communicate with STOW using the LMSInitialize( ) and LMSFinish( ) commands.

3.3.1.2.3.2. Assessment Learning Object Communication

Assessment Learning Objects will additionally communicate user scores on Assessment Object Objectives using the GetValue( ) and SetValue( ) commands and a subset of the AICC Data Model listed in Appendix 2.

3.3.1.3. Teaching Scripts

3.3.1.3.1. Presentation to Learner

Teaching Scripts define the sequencing of Learning Objects and Dialogue within a Teaching Goal but will not be presented to the user other than in this indirect form, i.e., they are not available for browsing.

3.3.1.3.2. Semantics

There is one Teaching Script for each Teaching Goal in the Teaching Goal Agenda. The Teaching Script is a property (TG_Teaching_Script) of the Teaching Goal.

A Teaching Script represents the total sequence of teaching actions that the Coach Agent will execute when the associated Teaching Goal is the current goal in the Teaching Goal Agenda. A Teaching Script is composed of a sequence of Teaching Script Modules that is defined by the Author. A Teaching Script or parts of a Teaching Script may be repeated more than once per Learner depending on the value authored for TSM_ReUse for the Teaching Script Modules it contains.

3.3.1.3.3. Properties

TS_Value: an ordered list of Teaching Script Modules

TS_Description: An optional short text description, possibly a short paragraph, which should describe the rationale and intent of the agenda, and suitable for use in internal documentation.

3.3.1.4. Teaching Script Module

3.3.1.4.1. Semantics

Teaching Script Modules are the first-level components of Teaching Scripts.

A Teaching Script Module specifies a pedagogically desirable sequence of one or more Dialogue and Learning Object types.

At run-time a TSM instance may be executed more than once per Learner if (a) the Teaching Script containing it is restarted by the Coach and (b) the Author defines the TSM instance as one that may be repeated.

CAT and CAS include these Teaching Script Module types:

Instruction Module:

1. Instruction Dialogue

2. Instruction Object

3. Instruction Dialog

Feedback Module:

1. Instruction Dialog

2. Assessment Object

3. Feedback Dialog

Simple Instruction Module

Instruction Dialog

3.3.1.4.2. Properties

TSM_ID: A unique internal identifier for the TSM instance; may be generated relative the name of the Teaching Goal associated with the Teaching Script containing the module.

TSM_Description: An optional short text description, possibly a short paragraph, which should describe the rationale and intent of the TSM, and is suitable for use in internal documentation; initialized from the corresponding of the predefined TSM type.

TSM_Value: An instance of a predefined ordered list of Dialogues and Learning Objects; the list structure is fixed; the specific instances of Dialogues and Learning Objects are fully authorable.

TSM_ReUse: an integer denoting whether or not CAS may reuse the TSM if it restarts the Teaching Script containing the TSM for a Learner; “0” or “1” denotes “no” (i.e., the TSM may be executed one time), positive integers greater or equal to “2” denote the maximum number of times the TSM may be executed.

3.3.1.5. Teaching Goals

3.3.1.5.1. Presentation to Learner

Teaching Goals for an Application are presented to the Learner as an ordered list in a Teaching Goal Navigation Structure in a frame on the left hand side of the browser window in which the STOW Application is running.

Each Teaching Goal is presented at runtime by the Coach using the TG_Description whenever that Teaching Goal is made the current goal for the Learner (either through coach recommendation or by the Learner selecting the goal from the Teaching Goal Navigation Element.

3.3.1.5.2. Properties

Teaching Goals may have additional properties defined in CAT to assist Authors in Application creation.

TG_Name—bound by the CAS into Autonomous Dialogue at runtime.

TG_Description—bound by the CAS into Auotonomous Dialogues at runtime.

TG_Teaching_Script—A Teaching Script for achieving this goal to be executed by CAS when this goal is the current goal to be achieved in the Teaching Goal Agenda.

TG_Evaluation_Standard: An ordered list of two integers, m and n, representing performance measures in the range 0 to 100, which together define three ranges such that {0,m} defines “poor” achievement, {m,n} defines “moderate: achievement, and {n,100} defines “high achievement” of the goal.

3.3.1.6. Teaching Goal Agenda

3.3.1.6.1. Presentation to Learner

The Teaching Goal Agenda is presented to the Learner as the Teaching Goal Navigation Structure.

3.3.1.6.2. Semantics

Each Application has one Teaching Goal Agenda, which is an ordered list of Teaching Goals defined in that application.

The Teaching Goal Agenda specifies the order in which the Coach seeks to have Teaching Goals achieved by each Learner.

At run-time, the Current_Teaching_Goal is first goal on the agenda that is not yet achieved for each Learner and is represented and stored persistently in the LPD.

Although the present Teaching Goal Agenda is defined as a linear sequence, it will be apparent to one skilled in the art that a more sophisticated Coach might select and sequence Teaching Goals differently for different Learners, for example in dependence upon a particular Learner's progress, preferences, etc.

3.3.1.6.3. Properties

TGA_Name: An optional short name for the agenda suitable for referring to it in internal and external documentation

TGA_Description: A optional short text description, possibly a short paragraph, which should describe the rationale and intent of the agenda, and suitable for use in internal and external documentation

TGA_Value: The ordered list of Teaching Goals

3.3.1.7. Dialogues

3.3.1.7.1. Semantics

Dialogues specify text content used by CAS to generate direct output by the Coach (e.g., spoken via text-to-speech).

There are two types of Dialogues: Instruction Dialogues and Feedback Dialogues.

Instruction Dialogues are intended for descriptive, prescriptive, or motivating content that usually refers to specific Teaching Goals, Learning Objects, and Learner profile information.

Instruction Dialogues should enable Authors to reference at least the following:

name of current Learner

name and description of current Teaching Goal

name and description of next Teaching Goal

name and description of last Instruction Object

name and description of next Instruction Object

Feedback Dialogues are intended for diagnostic and motivating content that refers to specific Teaching Goals, Learning Objects (Assessment type only), and Learner performance and status data. It is intended here that Feedback Dialogues will normally only follow an Assessment Object as predefined in the structure of an Instruction Module.

Instruction Dialogues should also enable Authors to reference the:

name of current Learner

name and description of the current Teaching Goal (assumed to be related to the most recent Assessment Object)

names and descriptions of all Teaching Goals defined for the preceding Assessment Object

name and description of the most recent Assessment Object

Pass/Fail status of Learner's achievement on each Teaching Goal defined for the preceding Assessment Object

Dialogues are created in three authoring contexts:

as components of Teaching Script Modules

as properties of Learning Objects

as properties of Teaching Goals

The content of Dialogues in Teaching Script Modules may be composed at publish- or run-time with the content of Dialogues defined as properties for a Learning Object used in the module and for the Teaching Goal the Teaching Script is associated with; the intent here is to enable Authors to re-use shared dialogue content of a more general nature when a TSM executes. How the shared content is used is specified in each instance on a per Dialogue basis for each TSM.

The content of Dialogues may be augmented at run-time by personalized, context dependent text generated at run-time by the Coach Agent.

3.3.1.7.2. Properties

DIA_ID: A unique internal identifier for the Dialogue instance (auto-generated)

DIA_Description: An optional short text description providing a comment about the Dialogue suitable for use in internal documentation

DIA_Type: An enumerated type with possible values

Instruction: Dialogue specifies content for a uninterrupted block of Coach output, which may, as determined by CAS at run-time, be immediately preceded or followed by dynamically-generated, context-sensitive content a.k.a. Autonomous Dialog.

Feedback: Dialogue specifies content for two sequential blocks of Coach output, which are intended to bracket dynamically-generated content based on results obtained from an Assessment Object that precedes the Dialogue in an Assessment Module.

DIA_Dialog_Templates: The syntax of this value is different for Instruction and Feedback Types.

Instruction: an ordered list of three (3) Dialogue Templates, where the first template is intended for use the first time the Dialogue is executed and the second and third templates are used in order on subsequent executions, if any, and then repeated as necessary as controlled by run-time strategies in CAS.

Feedback: an ordered list of three (3) pairs of Dialogue Templates, where the first template is intended for use the first time the Dialogue is executed and the second and third templates are used in order on subsequent executions, if any, and then repeated as necessary as controlled by run-time strategies in CAS.

3.3.1.8. Dialogue Templates

3.3.1.8.1. Semantics

Dialogue Templates are the main data contained within Dialogues as the value of the DIA_Dialog_Templates property of each Dialog.

Dialogue Templates contain the authored text content to be “spoken” by the Coach agent in CAS.

3.3.1.8.2. Properties

DT_ID: A unique internally generated string or token identifier for each Dialogue Template.

DT_Value: A string conforming to the syntax described in the following subsection.

DT_URL: An optional URL for a static or dynamically generated web page to be displayed in the main window of the Learner's client browser when the Coach is delivering the content of the Dialogue Template. If empty, then the browser window content will not change.

3.3.1.8.3. Syntax

The underlying syntax DT_Value is a sequence of literal strings and markup tags which are concatenated to produce a string at publish-time or run-time of the application.

Legal tags are defined by an enumerated and predefined set.

Tags reference context-dependent data that is bound either at publish-time or run-time of the application.

The syntax of markup tags should conform to common markup language conventions, as exemplified by HTML.

The underlying syntax of dialogue templates should conform to XML technology standards.

3.3.2. Learner Information

3.3.2.1. Data Source

Information about Learners that is Application specific is stored in the Learner Profile Database. Information about Learners that is general is stored in the Master Database for a STOW installation.

3.3.2.2. Universal Learner Description

3.3.2.2.1. Semantics

The Universal Learner Description is an object represented in the STOW Master Database which has properties defined on it representing characteristics of the Learners registered to this installation of STOW that remain consistent across Applications.

3.3.2.2.2. Properties

The Universal Learner Description for a Learner will represent at least the following desired properties

ULD_User_ID: The user ID that the Learner uses to Login to and Register for STOW Applications.

ULD_Password: The password that the Learner uses to Login to and Register for STOW Applications.

ULD_Applications: An unordered list of the Applications that the Learner is enrolled in. This is updated when the Learner registers for an Application and consulted when the Learner attempts to login to an application.

3.3.2.3. Global Learner Profile

3.3.2.3.1. Semantics

This object, to be represented within the Master Database will store information regarding Learner properties that are persistent and universal, i.e. may be applied to all Applications in the STOW installation, and may be instantiated by the Coach for a specific Learner from within any Application that the Learner is registered on.

3.3.2.3.2. Properties

The following desired properties are represented for Learners in the STOW Master Database.

ULP_Nickname: Learner's system nickname—the name of the Learner called by the Coach in all Applications.

ULP_Review_Correct_Goals: Information about whether the user wants to receive positive feedback on goals achieved after an attempt at an Assessment Object.

ULP_Coach_Incorrect_Goals: Information about whether the user wants to receive coaching dialogue after failing to master an Assessment Object.

3.3.2.4. Application Specific Learner Status

3.3.2.4.1. Teaching Goal Agenda

3.3.2.4.1.1. Properties

Current_Teaching_Goal—The Teaching Goal currently being attempted by a Learner. When a Teaching Goal is completed, the Current_Teaching_Goal is determined by traversing the Teaching Goal Agenda, looking for the next Teaching Goal that the Learner has not attempted.

3.3.2.4.2. Teaching Goals

3.3.2.4.2.1. Properties

TG_Status: An enumerated value with the following possible values:

TG_Not_Attempted: This Teaching Goal has not been attempted by the Learner.

TG_Attempted: This Teaching Goal has been attempted by the Learner but not completed

TG_Mastered: This Teaching Goal has been mastered by the Learner; either the Teaching Script for this Teaching Goal contained only Instruction Objects and all of these have been completed by the Learner, or the Teaching Goal Teaching Script contained Assessment Objects and the Learner has completed these, attaining a “high achievement” rating on the Evaluation Standard for this Teaching Goal.

3.3.2.4.3. Teaching Scripts

3.3.2.4.3.1. Properties

TS_Current_Module: This property is only instantiated on a Teaching Script when the Teaching Goal to which the Script is attached is the Current_Teaching_Goal. The property contains a reference to one of the Teaching Script Modules that make up this Teaching Script. This indicates the Learner's current position within the Teaching Script.

3.3.2.4.4. Teaching Script Modules

3.3.2.4.4.1. Properties

TSM_Times_Attempted: This property is attached to a Teaching Script Module and is updated by the Coach at runtime every time the Learner attempts this Teaching Script. For every Teaching Script Module within the current Teaching Script, the TSM_ReUse property must be compared to the TSM_Times_Attempted of the Teaching Script in order to evaluate whether the module may be attempted by the Learner this time or whether its allowed number of reuses has been exceeded.

3.3.2.4.5. Learning Objects

3.3.2.4.5.1. Properties

LO_Status: Conveys the status of the Learning Object with respect to this Learner. This property is only instantiated when the Teaching Script Module that contains this Learning Object is the TS_Current_Module for the Teaching Script associated with the Current_Teaching_Goal. An enumerated value with the following possible values:

LO_Unitialized: Learning Object has not been launched.

LO_Initialized: Learning Object has been launched—this value is given when an LMSInitialize( ) call has been received from the object through the STOW runtime API.

LO_Finished: Learning Object has finished execution—this value is given when an LMSFinish( ) call has been received from the object through the STOW runtime API.

LO_Times_Attempted: An array of values with a member for each of the number of times the Learner has attempted this Learning Object.

LO_Duration: A property attached to each member of the LO_Times_Attempted array indicating how long the Learner was interacting with the Learning Object. Calculated as the time difference between the LMSInitialize( ) and the LMSFinish( ) calls made by the object.

3.3.2.4.6. Assessment Objects

3.3.2.4.6.1. Properties

LO_Teaching_Goals_Scoring_Current_Values: An array of values indicating the scores that the user obtained on the Assessment Object Scoring Goals.

LO_Teaching_Goals_Scoring_Past_Values: A two-dimensional array indicating any past arrays of scores on Assessment Object Scoring Goals for this Learning Object attached to the attempt number on the Learning Object.

3.3.2.5. Learner Preference

3.3.2.5.1. Semantics

The Coach will maintain a Preference Object for each Learner active on an Application, upon which properties are defined describing the observed transient preferences and emotional state of that user. The values of these properties are used to conditionalize the delivery of Autonomous Dialogue and Authored Dialogue by the Coach.

3.3.2.5.2. Properties

The desired properties to be represented on a Learner Preference object include the following:

LP_Current_Mood: This property to be instantiated if the Coach gets a response from a Learner to an Autonomous Dialogue question about the Learner's mood. An enumerated value with the following values:

LP_Frustrated

LP_Confident

LP_Review_Correct_Goals: This Boolean property is to be instantiated if the Coach two or more responses from a Learner to a question after an Assessment Object about whether the Coach should give feedback on the LO_Teaching_Goals_Scoring that the user attained on that Object.

LP_Coach_Incorrect_Goals: This boolean property is to be instantiated if the Coach two or more responses from a Learner to a question after an Assessment Object about whether the Coach should give coaching on the LO_Teaching_Goals_Coaching that the user did not attain on that Object.

LP_Future_Prediction: Instantiated when the Coach gets a response from the Learner to a question regarding their projections about future performance. An enumerated value with the following values:

LP_Positive

LP_Negative

3.3.2.6. STOW Application Information

3.3.2.6.1. STOW Application

3.3.2.6.1.1. Semantics

In addition to the Curriculum Information represented about an Application in its STOW Content Database, certain pieces of information about the Application is uploaded to the Master Database by the STOW Upload Skills tool at publish time. This information controls user registration and logins for all Applications.

3.3.2.6.1.2. Properties

SA_Password: The password used to login to this Application.

3.3.2.6.2. Application List

3.3.2.6.2.1. Semantics

An unordered list of all Applications that have been published in this installation of STOW.

3.3.3. Importing Authored Applications

Authored STOW Content Databases and associated Learner Profile Databases are uploaded into the STOW CAS relational database management system by the STOW Upload Skills program.

The STOW Upload Skills program will also update the Master Database for the STOW installation, adding a record indicating the Application name and database names if this is the first time the Application has been published.

The STOW CAS Admin front page automatically adds the new Application to the list of available applications and login, registration and launch for the Application will be made available.

For this reason, the STOW Upload Skills tool will need to distinguish between the first time an Application is published to the STOW CAS and subsequent updates.

3.4. Application Interface

3.4.1. General Design

3.4.1.1. Structure

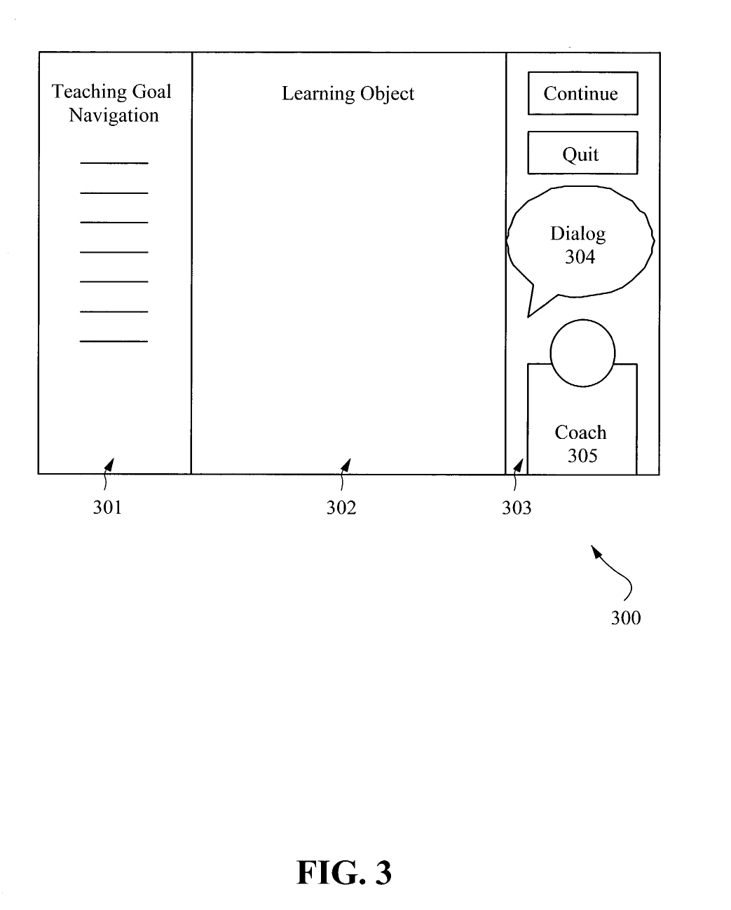

The Application interface comprises a user-friendly graphic user interface (GUI) presented within a screen or a browser window. Referring to FIG. 3, GUI 300 comprises a Teaching Goal Navigation frame 301, a Learning Object frame 302, and an interaction frame 303. A Coach 305 is represented as an animated character in frame 303, with coach dialogue appearing as text in a speech bubble 304 and also being relayed through a text-to-speech system (TTS), if feasible.

3.4.1.2. Navigation Elements

An outline listing the Teaching Goals of the Application appears on a side of the GUI. In FIG. 3, the Teaching Goals list is presented in frame 301. The list provides selectable links to the Teaching Goals. The Learner may select a Teaching Goal at any point in an Application in order to stop what they are doing and move on to that Goal. The Learner's choice (the selected Teaching Goal) is immediately communicated to the Coach.

It will be apparent to one skilled in the art that allowing a Learner to select and sequence Teaching Goals in this manner is one of many alternative ways in which a Coach might permit a Learner to influence the course of the learning experience. The present invention does not favor any one of these over the others, but permits different design decisions for different applications.

3.4.1.3. Interaction Model

In the present embodiment, the Coach presents dialogue to the Learner in a speech bubble and possibly through a TTS or other voice technology. In addition, the Coach may present non-verbal communications though gesture, facial expression, body language, etc. It will be apparent to one skilled in the art that these means of communication from Coach to Learner could be modified or extended with other electronic communications channels. The Learner presents dialogue to the Coach by selecting buttons such as: “Continue,” “Quit,” “Yer,” “No,” or one of the Teaching Goals. It will be apparent to one skilled in the art that this means of communication from Learner to Coach can be modified or extended, for example, with additional buttons for use by the Learner or a text window or voice software permitting the Learner to input natural language dialogue or with other electronic communications channels.

The Learner will interact with Learning Objects according to whatever interaction model is designed into the objects.

3.4.1.4. Recommendation Mechanism

Referring to FIG. 3, the Coach's recommendations for Learning Objects are conveyed in dialogue via speech bubble 304 and a Learner follows them by selecting the “Continue” button in frame 303. If the Learner does not wish to follow a recommendation, the Learner may choose another Teaching Goal outlined in frame 301 or end the STOW session by selecting the “Quit” button in frame 303.

It will be apparent to one skilled in the art that the Coach and Learner could “discuss” the recommendation through other communications channels as discussed heretofore in the Interaction Model section.

3.5. Platform

3.5.1. Programming language(s)

The current best embodiment of the STOW CAS and associated Coach applications are written using Extempo's proprietary character creation tool and associated scripting language. The runtime API is coded in JavaScript. However, it will be apparent to one skilled in the art that the STOW CAS and associated Coach Applications could be written in an alternative character creation tool and scripting language that provided functionality similar to the Extempo Imp Technology.

3.5.2. Application Server OS

The STOW CAS operates equivalently on the Windows NT 4 and Windows 2000 operating systems. (However, it will be apparent to one skilled in the art that the software could readily be ported to a Unix, Linus, Java, or other platform.)

3.5.3. Client Technologies

A broad range of client implementations with minimum client requirements can be employed with the STOW Coach. These client implementations differ in the richness of the media experience they deliver and also in the client platforms that support support them.

3.5.4. Database

STOW CAS will use an ODBC compliant enterprise quality commercial or supported open source Relational Database Management System to hold the Master Database, STOW Content Database and Learner Profile Database. In the first instance the preferred implementation is Microsoft SQL Server.

3.6. Installation

Self-Extracting archives of the STOW CAS can be made available to customers either on CD or over the web. When the archive is extracted to a target server, the resulting folder structure should contain:

1) Installation instructions—these may take the form of documents and parameterized installation and configuration scripts that can be edited with a system text editor.

2) All STOW CAS components.

3.7. Management

The STOW CAS can be manageable on the server using, e.g., the Web Server administration interface, the Windows Services Control Panel, the Extempo World Manager and the Relational Database Management System administration interface. (However, it will be apparent to one skilled in the art that the software could readily be ported to a Unix, Linus, Java, or other platform.)

4. STOW CAT Specifications

4.1. Architecture

4.1.1. General

STOW CAT is a client-based application (a stand-alone client program) supporting persistent storage of its data in ASCII files and a relational database (together comprising the STOW CAT Content Database) on the local or LAN-mounted file system. There are no requirements or specifications for management interfaces. STOW CAT accesses external SCORM descriptions via the file system or via HTTP access to any accessible web server.

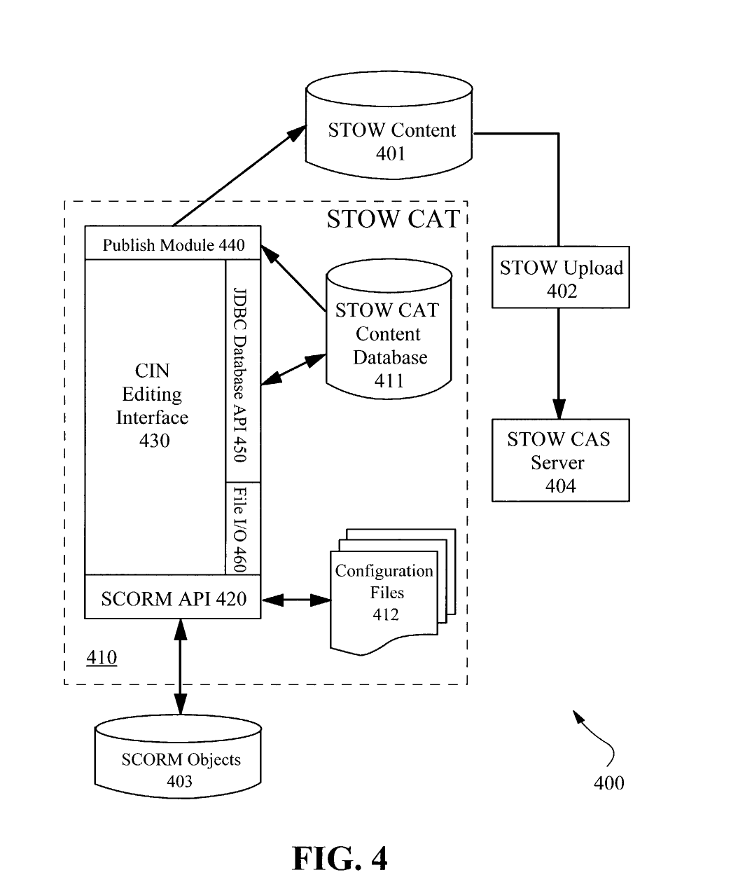

Referring to FIG. 4, architecture 400 comprises STOW CAT 410 and associated external components. An exemplary pattern for using architecture 400 is as follows:

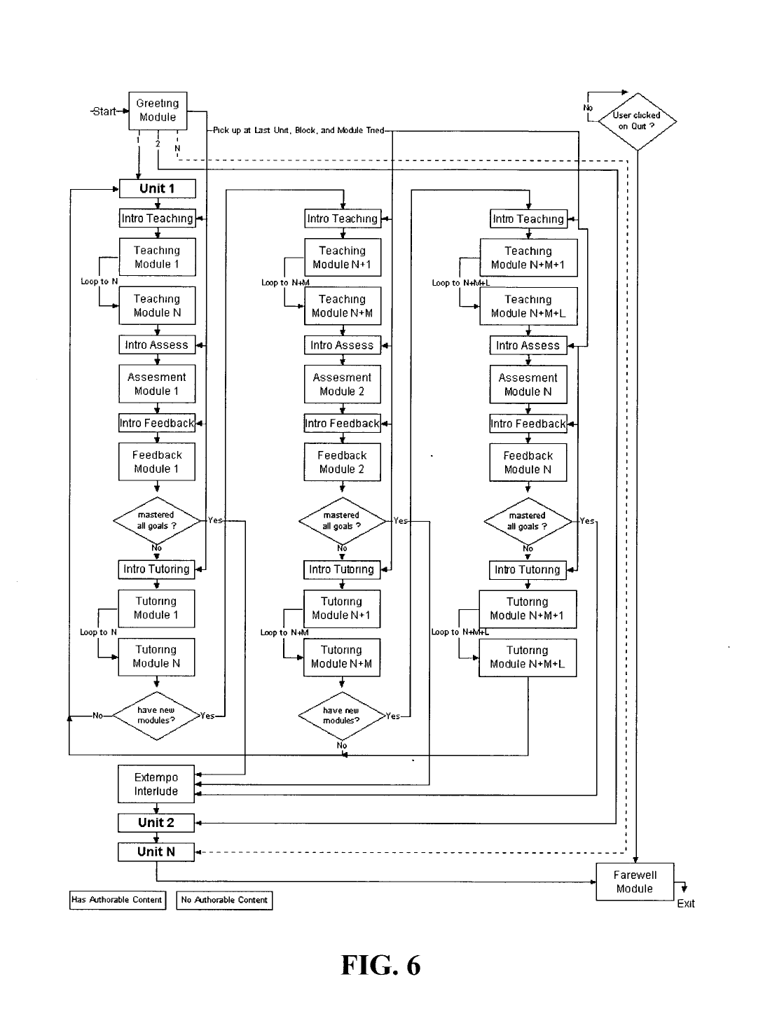

1. import, via SCORM API 420 and with Configuration Files 412, of SCORM (and any other supported) Learning Object references 403 when a new Application is first created and possibly in later authoring sessions (see, also, FIG. 6);

2. storage and retrieval, via CIN Editing Interface 430, File I/O 460, and JDBC Database API 450, of SCORM reference data to/from STOW CAT Content Database 411 during a series of authoring sessions (see, also, FIG. 6);

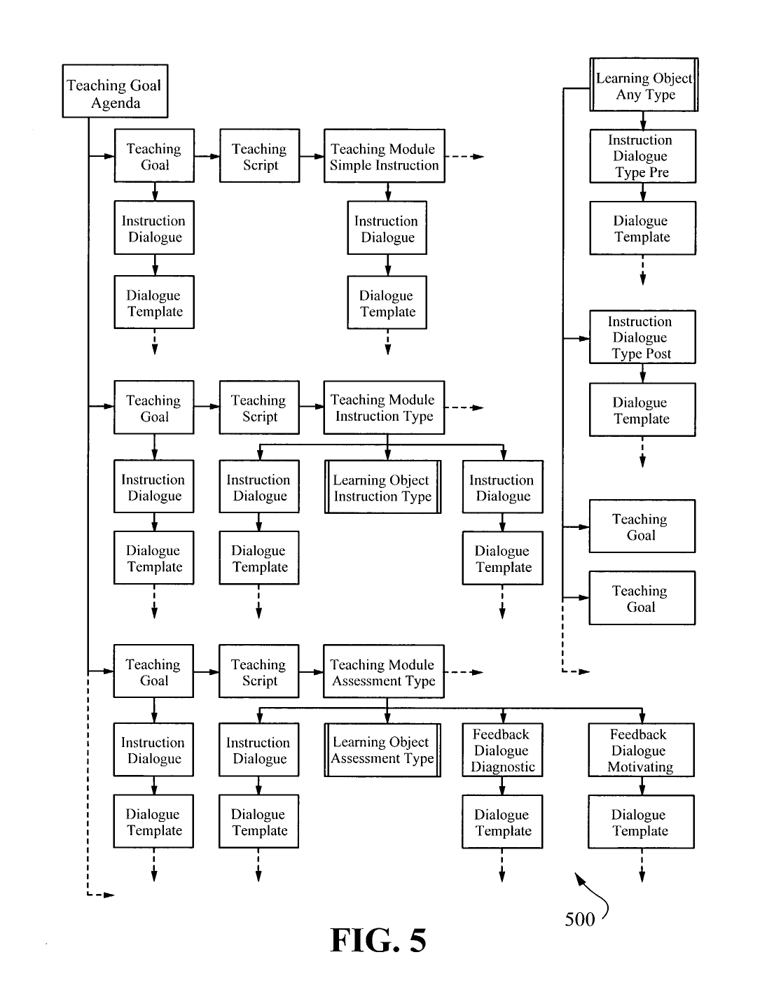

3. storage and retrieval of CIN (illustrated in FIG. 5) object definitions and content STOW CAT Content Database 411 during a series of authoring sessions (see, also, FIG. 6);

4. publish, via Publish Module 440, STOW CAT Content Database 411 to STOW Content Database 401 (the format used by STOW CAS) and uploading the STOW Content Database 401 to the CAS server 404 using the STOW Upload utility 402;

5. test (outside CAT), using the CAS server and STOW Client; and

6. repeat activities 2 through 5 until the Application behavior is satisfactory to the author.

4.1.2. CIN

All authored and imported content objects, including Learning Objects, Teaching Goals, the Teaching Agenda, Teaching Scripts, Teaching Script Modules, Dialogues, and Dialogue Templates, are represented in the Curriculum Information Network (CIN). The top-level structure of the CIN is illustrated in FIG. 5. CIN 500 conforms to specifications for each object type listed herein.

4.1.3. Data representation

STOW CAT run-time data structures and types for CIN objects efficiently map to relational database schemas and to standard primitive types supported in commercial relational databases, as well as to XML document definitions (or schemas).

4.1.4. Data storage

Configuration properties for each Application are stored in a per-Application configuration file within a local (or network file system) folder selected or created by the Author when the Application is created.

All authored information for an Application (the CAT Content Database) is stored in relational database and other files within an automatically created and named sub-folder of the folder containing that application's configuration file.

All authored content is saved transparently and incrementally via implicit database calls (without an explicit “Save” command) except where otherwise described in the specification.

4.1.5. External Interfaces

STOW CAT supports the SCORM interface standard to import to the CIN metadata about external Learning Objects that can be invoked at runtime in the authored CAS Application (see the STOW CAT Specification document and SCORM references listed in the definition section). Additionally, STOW CAT uses JDBC as the interface to the CAT Content Database.

4.2. Authoring Interface

4.2.1. General Design

4.2.1.1. Organization

Authoring of multiple named coaching applications or named versions of the same Application should be supported within a single client installation.

Applications are defined and managed via menu commands such as:

New Application

Open Application

Save Application As . . .

Close Application

Authoring capabilities are organized to support flexible entry of content and metadata about Learning Objects, Teaching Goals, Teaching Scripts, and Dialogue Templates and the relationships among them.

Authoring capabilities include direct and indirect guidance (e.g., prompts, flags, wizards) to Authors for completing each of the following data entry tasks, which are required to complete an Application:

1. Importing references to the set of externally implemented Learning Objects for which coaching content is to be implemented.

2. Entering values for a pre-defined set of coaching-specific properties for Learning Objects and possibly overriding externally defined and imported values for these properties.

3. Defining the application's Teaching Goal Agenda from the set of Teaching Goals defined by the Author or in the reference data of imported Learning Objects

4. Authoring content for optional default Dialogues stored as properties of Learning Objects and Teaching Goals

5. Entering for each Teaching Goal a Teaching Script comprising a sequence of pre-defined Teaching Script Modules.

6. Entering the data for each Learning Object and Dialogue contained in each Teaching Script Module instance.

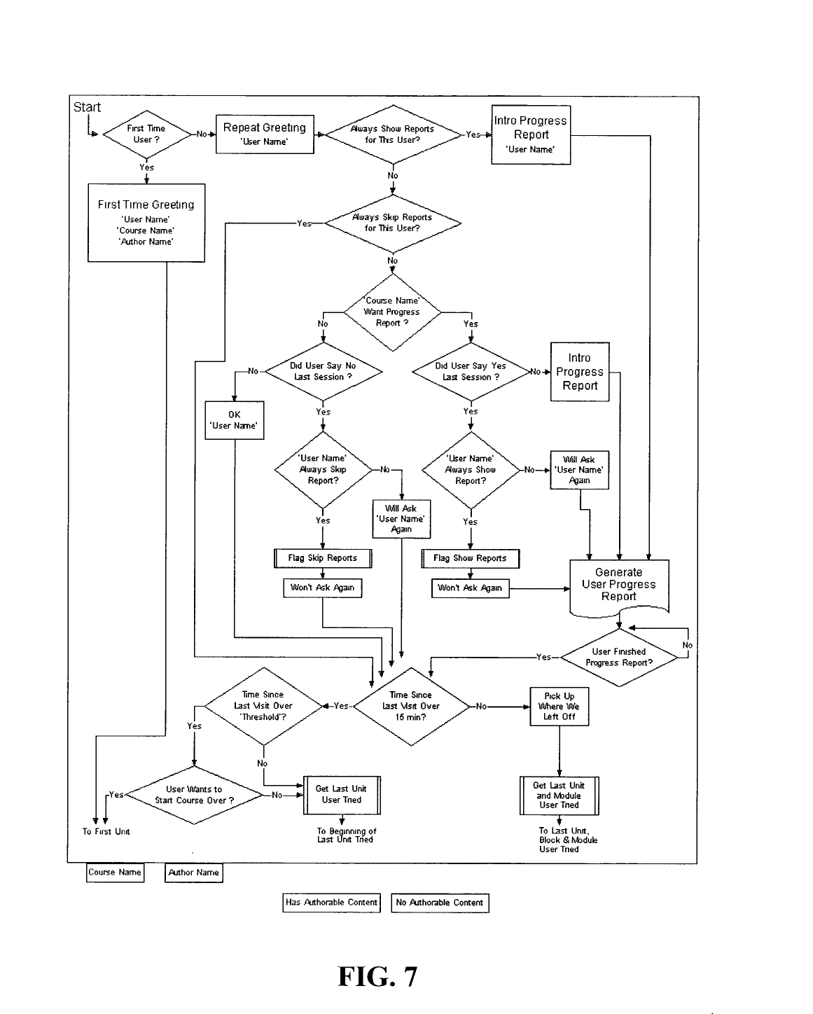

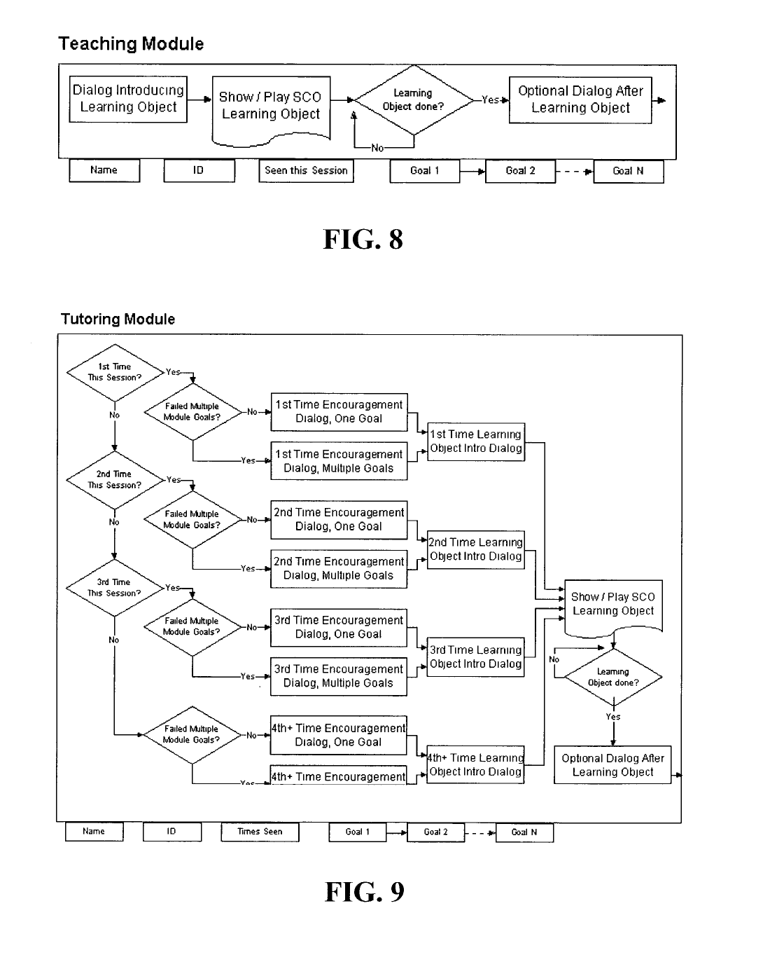

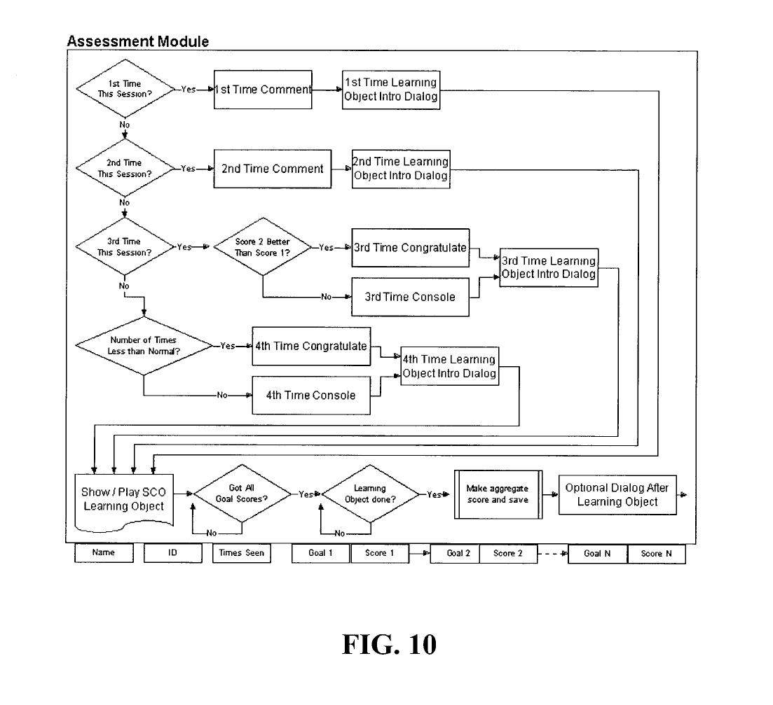

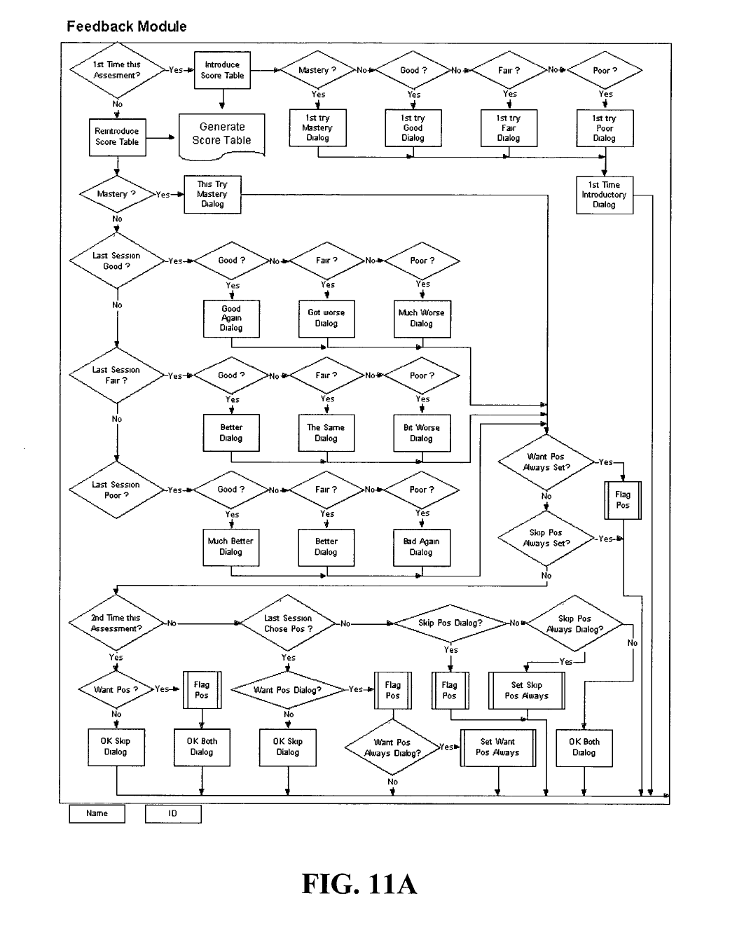

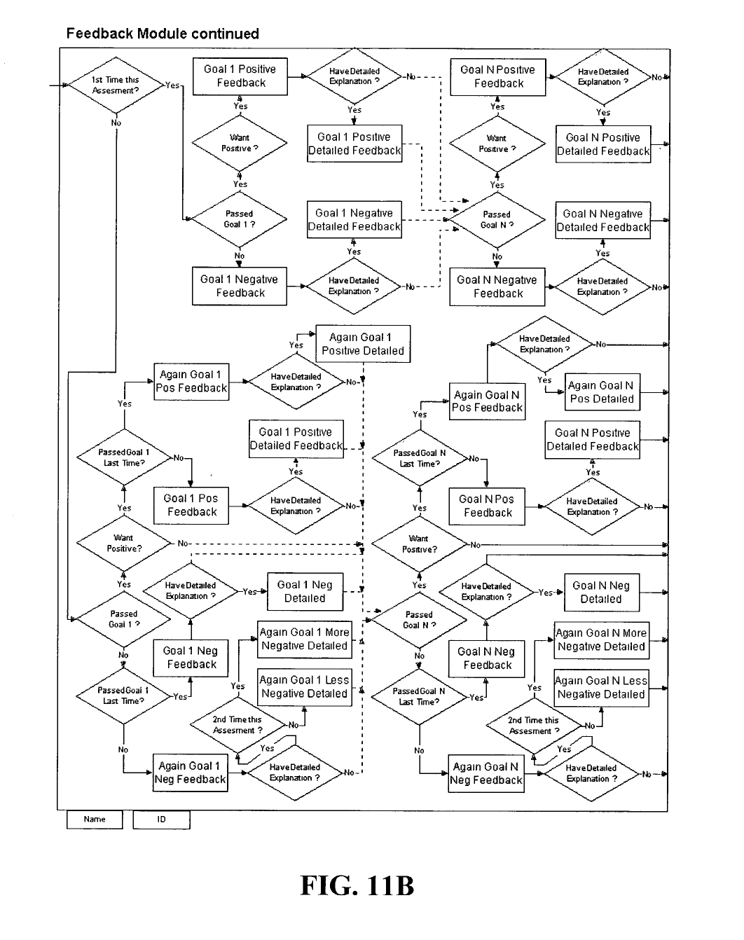

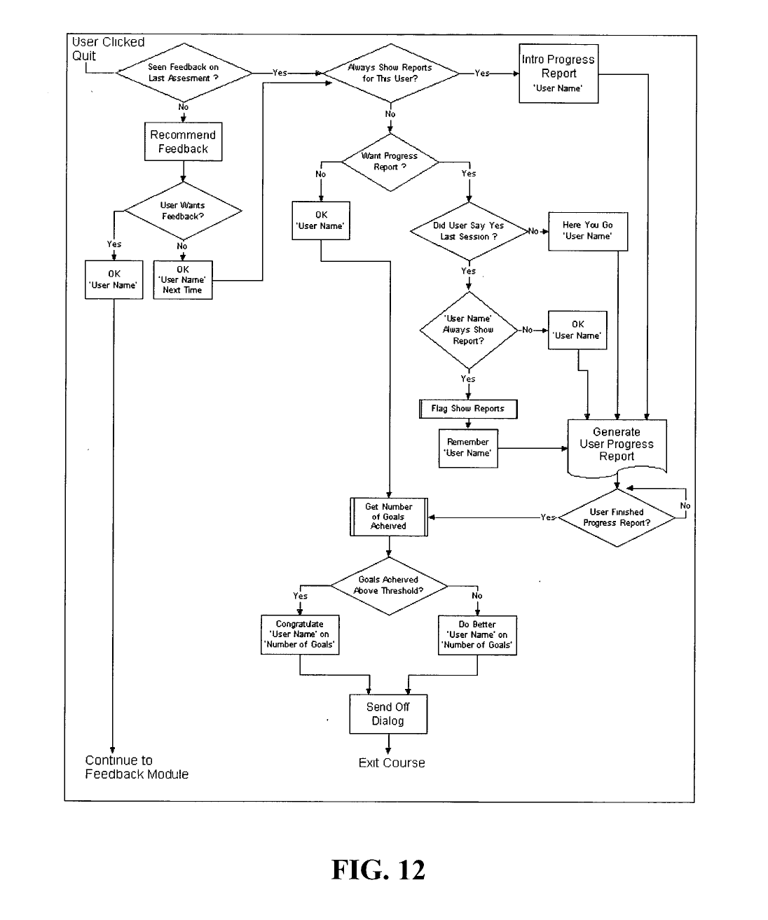

FIG. 6 illustrates how STOW authoring sessions flow. In FIG. 6 as well as in FIGS. 7-12, built-in coach expertise (content not authorable by STOW CAT Author) is shown in gray boxes and application-specific expertise (content authorable by Author of STOW CAT) is shown in white boxes with various shapes. As shown in FIG. 6, a STOW authoring session comprises implementing a Greeting Module, at least one learning unit (Unit 1-Unit N), and a Farewell Module. Each learning unit, as shown in detail with respect to Unit 1, comprises at least one Teaching Module, at least one Tutoring Module, at least one Assessment Module, and at least one Feedback Module. Further details related to the Greeting Module, the Teaching Module, the Tutoring Module, the Assessment Module, the Feedback Module, and the Farewell Module are respectively discussed herein and illustrated in FIGS. 7, 8, 9, 10, 11A-11B, and 12.

4.2.1.2. GUI Layout and Navigation

The top-level user interface includes a pane/window (not shown) providing an overall map of the CIN that signals status information relevant to authoring status of each object and that enables direct navigation to each object.

Initiating and switching among each data entry activities described herein is modeless, intuitive, and transparent.

In general, wherever a CIN object can be selected in a view, the interface supports direct navigation to a new view for editing the properties of that object which, if appropriate, reflect the context of the view from which the new view was accessed.

Data entry is constrained and checked in real-time against defined property value semantics. Data entry of numerical data types with a bounded range of values uses GUI widgets that show the range and limit entry to legal values. Data entry of enumerated data types uses GUI widgets that show the enumerated values and provides for data entry via selection of the desired value.

Menus, button bars, navigation commands, shortcuts, and other UI methods parallel where applicable those used in other content editors (e.g., visual Web page editors, text editors, drawing editors) that may be familiar to Authors.

4.2.2. Learning Objects

4.2.2.1. References

References to all Learning Objects used in an Application are stored under a single URL branch (e.g., in a single sub-folder) to be specified by the Author in the Application configuration file. These references conform to SCORM specification.

4.2.2.2. Properties [REQUIRED]

Learning Objects may have additional properties defined in CAS with values determined and used only at run-time.

LO_URL: A URL for invoking the Learning Object; initialized when reference data is imported via SCORM APIS (and possibly others)

LO_Metadata_URL: A URL for accessing the reference data for the Learning Object; copied from the configuration file data

LO_Name: A short name for the object suitable for labeling and listing within editing views and for binding into dialogue templates such as “After you've completed <LO_Name>, you'll understand . . . ”; initialized when reference data is imported

LO_Description: A short text description, possibly a short paragraph, which should describe the nature or purpose of the object; initialized when optional reference data is imported

LO_Type: An enumerated value with the following possible values:

Instruction_Object: The object does not return performance measures on Learner interaction with its content.

Assessment_Object: The object returns performance measures on Learner interaction with its content.

LO_Teaching_Goals_Scoring: (Functional for Assessment Objects only) A list of Teaching Goal objects denoting the Teaching Goals measured within the Learning Object for which the Learner Profile Database will be updated; initialized when optional reference data is imported; authored override is expected.

LO_Teaching_Goals_Coaching: A list of Teaching Goal objects denoting the Teaching Goals addressed by the Learning Object which any surrounding coaching, authored or autonomous, should be limited to; initialized when optional reference data is imported; Author override is expected.

LO_Assessment_Data_URL: If LO_Type=Assessment Object, then a URL for accessing the performance data generated when a Learner interacts with the object content; otherwise, value is undefined; initialized when optional reference data is imported

LO_Dialog_Pre: A optional Dialogue of type Instruction which Authors may create to provide shared default or additive content for Dialogues that are components of any Teaching Script Modules that execute the Learning Object. Use of this Dialogue will integrate with Dialogue that immediately precedes the Learning Object in a Teaching Script Module.

LO_Dialog_Post: A optional Dialogue of type Instruction if this is an Instruction Object and of type Feedback if this is an Assessment Object. It defines shared default or additive content for Dialogues that are components of Teaching Script Modules that execute the Learning Object. Use of this Dialogue will integrate with Dialogue that immediately follows the Learning Object in a Teaching Script Module.

4.2.2.3. Importing Property Values

An “Import Learning Objects” command on the top-level GUI menu (or similarly implemented) initializes values for defined Learning Object properties with any data available in the external references for the Learning Objects.

Any subsequent execution of the “Import Learning Objects” command overwrites previously imported property values, but does not overwrite Author-created or -modified values.

When execution of the “Import Learning Objects” command overwrites imported property values and there are Author-edited overrides for overwritten imported property values, the navigation interface highlights that authored information until either (a) the Author has (re-)edited the existing overridden data or (b) executed a “Clear Marked Changes” command.

4.2.2.4. Editing Property Values

The editing interface visually distinguishes properties that are defined only within CAT (and CAS) from those that are also defined and may have values set in external Learning Object references (i.e., from those that are included in the SCORM specification).

Editing of imported property values does not delete the imported values, but consists of creating and modifying new data that are linked to the imported data as an override.

The editing interface provides a view of properties that shows both imported values and any authored values that overrides them.

4.2.3. Teaching Goals

4.2.3.1. References

Teaching goals may be defined externally in the reference data for Learning Objects (as provided for in the SCORM specification. These may or may not correspond to an Author's model of the Teaching Goals for the specific application.) The editing interface provides a pane/window for globally viewing and editing the mappings (to TG_References) of imported goals data with Author Teaching Goal definitions.

4.2.3.2. Properties [REQUIRED]

Teaching Goals may have additional properties defined in CAS with values determined and used only at run-time.

TG_Name: A short name for the goal suitable for labeling and listing within CAT editing views and for binding into dialogue templates such as “Now that you have mastered <TG_Name>, you're ready to move on to . . . ”; initialized from optional data imported from Learning Object references.

TG_Description: A short text description, possibly a short paragraph, which should describe the value of the goal for the Learner.

TG_Learning_Objects: A list of Learning Objects that are relevant to achieving the Teaching Goal; initialized from optional data imported from Learning Object references

TG_References: A list of any imported SCORM-defined teaching goals (or “learning objectives”) that are mapped to this CIN Teaching Goal.

TG_Teaching_Script: A Teaching Script for achieving this goal to be executed by CAS when this goal is the current goal to be achieved in the Teaching Goal Agenda.

TG_Dialog: A optional Dialogue of type Instruction which Authors may create to provide shared default or additive content for Dialogues that are components of Teaching Script Modules in the Teaching Script defined in TG_Teaching_Script.

TG_Evaluation_Standard: An ordered list of two integers, m and n, representing performance measures in the range 0 to 100, which together define three ranges such that {0,m} defines “poor” achievement, {m,n} defines “moderate: achievement, and {fn, 100} defines “high achievement” of the goal. (Note: the exact from of this property value may need modification to support use of SCORM interfaces).

4.2.3.3. Importing Properties

Similar to Importing Properties Values of Learning Objects.

4.2.3.4. Editing

Similar to Editing Property Values of Learning Objects. Wherever a Teaching Goal is displayed in a view, visual flags will identify goals that a) are not included in the Teaching Goal Agenda or b) do not have a value defined for TG_Teaching_Script. Editing interface for the value of TG_Teaching_Script is discussed in the Teaching Scripts section.

4.2.4. Teaching Goal Agenda

4.2.4.1. Semantics

The Teaching Goal Agenda specifies the order in which the Coach seeks to have Teaching Goals achieved by each Learner. At run-time, the Current_Teaching_Goal is first goal on the agenda that is not yet achieved for each Learner and is represented and stored persistently in the LPD. Each Application defines one Teaching Goal Agenda, such as shown in FIG. 5, which is an ordered list of Teaching Goals defined in that Application.

4.2.4.2. Properties [REQUIRED]

TGA_Name: An optional short name for the agenda suitable for referring to it in internal and external documentation

TGA_Description: A optional short text description, possibly a short paragraph, which should describe the rationale and intent of the agenda, and suitable for use in internal and external documentation

TGA_Value: The ordered list of Teaching Goals

4.2.4.3. Editing

The TGA is identified and displayed in the top-level navigation pane/window by displaying the contents of TGA_Value as the names of the Teaching Goals in a manner that clearly suggests their ordering. The TGA view is desirably labeled using TGA_Name, if available.

The TGA view enables addition, deletion, and reordering of the goals in TGA_Value. The TGA view desirably employs visual, direct manipulation GUI widgets to enable addition, deletion, and reordering of the goals in TGA_Value.

TGA_Name and TGA_Description are editable via a standard GUI dialogue box that may be opened via a top-level menu command, a top-level button bar action, or context-menu in the pane/window displaying the TGA.

Wherever Teaching Goals are displayed, either in the main navigation pane/window or elsewhere, goals not yet included in the TGA is visually flagged for the Author's attention.

4.2.5. Teaching Scripts

4.2.5.1. Semantics

A Teaching Script represents the total sequence of teaching actions that the Coach Agent will execute when the associated Teaching Goal is the current goal in the Teaching Goal Agenda. A Teaching Script or parts of a Teaching Script may be repeated more than once per Learner depending on the values authored for TSM_ReUse for the Teaching Script Modules it contains. There should be one Teaching Script defined for each Teaching Goal in the Teaching Goal Agenda. The Teaching Script is a property (TG_Teaching_Script) of the Teaching Goal. A Teaching Script comprises a sequence of instances of pre-defined Teaching Script Modules.

4.2.5.2. Properties [REQUIRED]

TS_Value: an ordered list of Teaching Script Modules

TS_Description: An optional short text description, possibly a short paragraph, that describes the rationale and intent of the agenda, and suitable for use in internal documentation.

4.2.5.3. Editing—The Teaching Script Editor

A pane/window for editing Teaching Scripts (Teaching Script Editor) is accessible via one or more of a top-level menu command, a context-menu in the active pane/window, or a direct-manipulation GUI widget wherever a Teaching Goal can be selected.

The Teaching Script Editor is accessible via a button or other suitable GUI widget within the dialogue box for editing the properties of Teaching Goals.

The Teaching Script Editor a) displays TG_Name and TG_Description for the Teaching Goal to which the currently edited Teaching Script is associated and b) provides a GUI widget for editing TS_Value for that Goal.

The Teaching Script Editor includes commands for adding, deleting, and reordering instances of Teaching Script Modules in the TS_Value.

Adding a Teaching Script Module should be limited to selecting from a pre-defined set of TSMs, which will add an instance of the selected TSM to the current script.

4.2.6. Teaching Script Modules

4.2.6.1. Semantics

A Teaching Script Module specifies a pedagogically desirable sequence of one or more Dialogue and Learning Object types. At CAS run-time a TSM instance may be executed more than once per Learner if a) the Teaching Script containing it is restarted by the Coach and b) the Author defines the TSM instance as one that may be repeated. Teaching Script Modules should be the only top-level components within Teaching Scripts. CAT and CAS include the following Teaching Script Module types (with components sequenced as numbers):

Instruction Module:

1. Instruction Dialogue

2. Instruction Object

3. Instruction Dialog

Feedback Module:

1. Instruction Dialog

2. Assessment Object

3. Feedback Dialog

Simple Instruction Module

1. Instruction Dialog

4.2.6.2. Properties [REQUIRED]

TSM_ID: A unique internal identifier for the TSM instance; may be generated relative the name of the Teaching Goal associated with the Teaching Script containing the module.

TSM_Type: An enumerated value with possible values:

Instruction

Feedback

Simple_Instruction

Initialized when the instance is created and not editable.

TSM_Description: An optional short text description, possibly a short paragraph, which should describe the rationale and intent of the TSM, and is suitable for use in internal documentation; initialized from TSM_Type when the instance is created.

TSM_Value: An instance of a predefined ordered list of Dialogue instances and Learning Objects; initialized when the instance is created and not editable; the specific instances of Dialogues and Learning Objects are fully authorable.

TSM_ReUse: an integer denoting whether or not CAS may reuse the TSM if it restarts the Teaching Script containing the TSM for a Learner; “0” or “1” denotes “no” (i.e., the TSM may be executed at most one time), positive integers greater or equal to “2” denote the maximum number of times the TSM may be executed.

4.2.6.3. Editing—The Teaching Script Editor

Editing of Teaching Script Modules is integrated with that of Teaching Scripts in the Teaching Script Editor section. A selected TSM previously inserted into a Teaching Script is opened for editing via one or more of a top-level menu command, a context-menu in the active pane/window, or a direct-manipulation GUI widget. The view of a TSM opened for editing does the following:

provides a GUI widget for opening the Dialogue Editor (similar or identical to those available in other editing contexts) for the Dialogues in the TSM.

provides a GUI widget for associating the Learning Object references in the TSM to one of the Learning Objects defined in the CIN.

visually flags the display of the Dialogues and Learning Objects to indicate any that have missing required authored content.

provides a GUI widget for editing TSM_ReUse

4.2.6.4. TSM Management

A global management interface for all created TSMs is not implemented in this current embodiment. TSM creation, deletion, and editing are managed solely within the view for editing Teaching Scripts.

4.2.7. Dialogues

4.2.7.1. Semantics

Instruction Dialogues are intended for descriptive, prescriptive, or motivating content that usually refers to specific Teaching Goals, Learning Objects, and Learner profile information. Dialogues define text content used by CAS to generate direct output by the Coach (e.g., spoken via text-to-speech). Two important types of Dialogues are: Instruction Dialogues and Feedback Dialogues. Instruction Dialogues, at a minimum, enable Authors to reference the:

name of current Learner

name and description of current Teaching Goal

name and description of next Teaching Goal

name and description of last Instruction Object

name and description of next Instruction Object

Feedback Dialogues are intended for diagnostic and motivating content that refers to specific Teaching Goals, Learning Objects (Assessment type only), and Learner performance and status data. It is intended here that Feedback Dialogues will normally follow an Assessment Object as predefined in the structure of an Instruction Module. Feedback Dialogues, at a minimum, enable Authors to reference the:

name of current Learner

name and description of the current Teaching Goal (assumed to be related to the most recent Assessment Object)

names and descriptions of all Teaching Goals defined for the preceding Assessment Object

name and description of the most recent Assessment Object

Pass/Fail status in the LPD of Learner's achievement on each Teaching Goals defined for the preceding Assessment Object

The editing interfaces enable Dialogues to be created in three authoring contexts:

as components of Teaching Script Modules

as properties of Learning Objects

as properties of Teaching Goals

The content of Dialogues in Teaching Script Modules may be composed at publish- or run-time with the content of Dialogues defined as properties for a Learning Object used in the module and for the Teaching Goal the Teaching Script is associated with; the intent here is to enable Authors to re-use shared dialogue content of a more general nature when a TSM executes. How the shared content is used is specified in each instance on a per Dialogue basis for each TSM. The content of Dialogues may be augmented at run-time by personalized, context dependent Autonomous Dialog

4.2.7.2 Properties [REQUIRED]

DIA_ID: A unique internal identifier for the Dialogue instance (auto-generated)

DIA_Description: An optional short text description providing a comment about the Dialogue suitable for use in internal documentation

DIA_Type: An enumerated type with possible values

Instruction: Dialogue specifies content for a uninterrupted block of Coach output, which may, as determined by CAS at run-time, be immediately preceded or followed by Autonomous Dialog

Feedback: Dialogue specifies content for two sequential blocks of Coach output, which are intended to bracket Autonomous Dialogue coach on Learner performance in an Assessment Object that precedes the Dialogue in an Assessment Module.

Initialized when the Dialogue instance is created and not editable

DIA_Dialog_Templates: The syntax of this value varies for Instruction and Feedback Types.

Instruction: an ordered list of three (3) Dialogue Templates, where the first template is intended for use the first time the Dialogue is executed and the second and third templates are used in order on subsequent executions, if any, and then repeated as necessary as controlled by run-time strategies in CAS

Feedback: an ordered list of three (3) pairs of Dialogue Templates, where the first template pair is intended for use the first time the Dialogue is executed and the second and third template pairs are used in order on subsequent executions, if any, and then repeated as necessary as controlled by run-time strategies in CAS

4.2.7.3 Editing—The Dialogue Editor

A pane/window for editing Dialogues (the Dialogue Editor) should be accessible via one or more of a top-level menu command, a context-menu in the active pane/window, or a direct-manipulation GUI widget wherever a Dialogue can be selected. The Dialogue Editor should be accessible via a button or other suitable widget within the dialogue boxes for editing the properties of Teaching Goals and Learning Objects in order to create and edit Dialogues that are the values of TG_Instruction_Dialogue and LO_Dialog_Pre and LO_Dialog_Post.

The top-level of the Dialogue Editor should display the DIA_Type and DIA_Description. DIA_Type should not be editable since it should be determined and set within the context where the Dialogue is first created. DIA_Description should be editable but no value is required. DIA_Dialog_Templates should be displayed and edited within the Dialogue Editor as described herein.

4.2.7.4 Dialogue Management

Dialogue creation, deletion, and editing is managed within the views for editing Teaching Script Modules, Learning Object properties, and Teaching Goal teaching properties. Views of Teaching Script Module content should visually flag Dialogues that are incomplete or have no content. Navigational views of Leaning Objects and Teaching Goals collections should visually flag those that have Dialogue values authored in their property values.

4.2.8. Dialogue Templates

4.2.8.1. Semantics

Dialogue Templates are the main data contained within Dialogues and are comprise the value of the DIA_Dialog_Templates property of each Dialog. Dialogue Templates contain the authored text content to be “spoken” by the Coach agent in CAS.

4.2.8.2. Properties [REQUIRED]

DT_ID: A unique internally generated string or token identifier for each Dialogue Template.

DT_Value: A string conforming to the Syntax described in the next section.

DT_Compose_Type: An enumerated type that specifies how DT_Value may be composed with shareable content contained in Dialogues stored with contextually relevant Learning Objects and Teaching Goals. Defined values are:

None: the current value is never augmented (default); fixed and only value for templates defined within a Dialogue stored as a property of a Learning Object or

Teaching Goal

Use_Default_LO: if the current value is empty, use the value from corresponding template of the Dialogue stored in LO Dialog_Pre or LO_Dialog_Post for the LO that either precedes or follows this Dialog, respectively.

Use_Default_TG: if the current value is empty, use the value from corresponding template of the Dialogue stored in TG_Dialogue for the current TG.

Use_Prefix_LO: prepend the value from corresponding template of the Dialogue stored in LO Dialog_Pre or LO_Dialog Post for the LO that either precedes or follows this Dialog, respectively.

Use_Postfix_LO: append the value from corresponding template of the Dialogue stored in LO_Dialog_Pre or LO_Dialog_Post for the LO that either precedes or follows this Dialog, respectively.

Use_Prefix_TG: prepend the value from corresponding template of the Dialogue stored in TG_Dialogue for the current TG.

Use_Postfix_TG: append the value from corresponding template of the Dialogue stored in TG_Dialogue for the current TG.

DT_URL: An optional URL for a static or dynamically generated web page to be displayed in the main window of the Learner's client browser when the Coach is delivering the content of the Dialogue Template. If empty, then the browser window content will not change.

4.2.8.3. Syntax

Tags reference context-dependent data that is bound either at publish-time or run-time of the application. The underlying syntax DT_Value is a sequence of literal strings and markup tags that are concatenated to produce a string at publish-time or run-time of the application. The viewable syntax of DT_Value should represent tags with meaningful tokens/names (i.e., hide tag syntax) that are perceptually distinct from the literal text they are embedded within. Legal tags are defined by an enumerated and predefined set.

The syntax of markup tags should conform to common markup language conventions, as exemplified by HTML. The underlying syntax of dialogue templates should conform to XML technology standards.

4.2.8.4. Editing—The Dialogue Editor

Editing of Dialogue Templates is integrated with that of containing Dialogues in the Dialogue Editor described herein. When a Dialogue is open for editing a GUI navigation/selection widget displays a map of all the possible Dialogue Template instances that can be edited within that Dialogue (note that maps will vary depending on the value of DIA_TYPE of the Dialog). The Dialogue Template map visually flags those Dialogue Template instances that are incomplete.

When an Author selects a Dialogue Template instance in the map a pane or dialogue box displays an editing interface for DT_Value and other editable properties of that template (note that editable properties will vary depending on whether the Dialogue is part of Teaching Script Module or is a property value for a Learning Object or Teaching Goal). The editing interface for DT_VALUE implements the following capabilities:

1. Free-form entry of literal text via an “Edit Window” GUI widget that supports conventional text navigation and Copy-Cut-Paste;

2. Insertion of context data references at the text cursor via a selection GUI widget (e.g., drop-down list box) adjacent to the Edit Window; relevant references that should be displayed for selection vary according to DIA Type of the containing Dialogue and should correspond to the Dialogue semantics described herein;

3. A “Save-and-Continue” action that the Author may invoke to write the current contents of the Edit Window to disk and continue work on the template;

4. A “Save” action that the Author may invoke to write the current contents of the Edit Window to disk and return to the prior editing context; and

5. A “Cancel” action to discard any changes to the current contents of the Edit Window and return to the prior editing context.

4.2.8.5. Dialogue Management

Dialogue Template creation, deletion, and editing is managed within the views for Dialogues when editing Teaching Script Modules, Learning Object properties, and Teaching Goal teaching properties.

4.3. STOW Upload

Upload a local STOW content database, as created by the Publish command, to a CAS server is effected outside of the CAT editing interface using a separate executable utility program, STOW Upload. STOW Upload reads configuration information required for controlling the upload process from a configuration file editable with a system text editor. The configuration file used to control STOW Upload conforms to XML representation standards. The system command to execute STOW Upload has one parameter, which is a file path or URL for the configuration file to be used. STOW Upload by default overrides data in the destination content database. STOW Upload reports errors to the system GUI if invoked interactively and in all cases (interactive and in a system command script) to a file (specified in the configuration file).

4.4. Platform

4.4.1. Programming language

STOW CAT and STOW Upload are implemented in Java as stand-alone applications (not applets), using a version of the Java language and runtime that supports current standards.

4.4.2. Workstation OS

STOW CAT and STOW Upload operate equivalently on the Windows 98, Windows 2000, and Windows XP operating systems. STOW CAT and STOW Upload operate equivalently on current Sun Solaris and Linux operating systems.

4.4.3. Database

STOW CAT and STOW Upload use for the local database a low-cost commercially available or supported open-source database system and engine that can be accessed via JDBC API drivers.

4.5. Installation

STOW CAT can be installed from a portable computer medium such as a compact disc (CD) or from a single download executable file via a standard installation utility product that

obtains installation option interactively from the use and automatically unpacks and configures all files necessary to start CAT immediately following installation;

writes minimal or no data to a System Registry or other such central application database, except as required to support de-installation.

STOW CAT can be completely uninstalled, except for databases created for authored content during its operation, via the host system's standard uninstall mechanisms.

5. Planned Extensions

The Application architecture and data storage plan described in this current best embodiment combine implementations of compiled Imp file and relational database for content, providing a practical and useful tool enabling content authors to write directly to the Imp database.

It would be useful to support implementation of alternative coaches with different pedagogical strategies without requiring the entire architecture as well as the authoring tool to be modified. This can be done by constructing different pedagogical strategies as “modules” that could be plugged into the Coach, independent of other mechanisms.

The AICC Data Model to be used for communication within the Learning Object API has an extensive vocabulary. The communication with Learning Objects can thus scale and become more complex in future developments.

The conceptualization of an Application as being made up of Teaching Script Modules is aimed at allowing non-technical Authors to create a relatively simple Application in a reasonable amount of time, and have it presented to the Learner with additional expertise from the Coach. Such simplicity is desired but not required and can be implemented to cover a very rich space of applications. The coaches can be enhanced with specific functional differentiation.

The overall efficiency and effectiveness of the STOW embodiment can be refined to better handle scalability, multiple external database calls throughout the operation of the Coach, plus interactions with external Learning Objects and the associated network latencies.

The STOW embodiment is intended to be compatible with future developments/implementations, including integration for external standards and complementary third party online training products, with the least amount of effort at an installation site, e.g., migration tools, etc., and the least amount of architectural change/recoding.

The STOW CAT described herein supports only external Learning Objects with SCORM interfaces. Wrapper interfaces may be created for non-SCORM Learning Objects for recognizing and importing them into CAT. Some CAT editing views are tied to specific hard-wired parameters for the structure of editable data, for example, three alternatives for each Dialogue Template, type specific views for each type of Dialogue, and a linear Teaching Goal Agenda as the single specification for top-level instructional strategy. Existing views be modified if and when these parameters are changed.

Concurrent authoring by multiple authors is a challenging issue with most authoring tools for creative tasks (e.g., consider support for multiple concurrent Authors in leading word processors). Concurrent development capabilities are supported to a reasonable extent only in tools for content that can be decomposed into separate chucks with abstract interfaces. Modern software development of object-oriented designs is one of the better examples of this. The current embodiment of the STOW CAT exploits this clean decomposition of the authoring task and does support concurrent authoring by multiple Authors to a substantial degree. Future implementations may provide additional support for multiple Authors to collaborate concurrently on content in the same CAT Content Database. SCORM is an evolving standard so interfaces to SCORM objects must also evolve. The role of SCORM interfaces in CAT relative to CAS is much more compartmentalized so any required changes are limited.

The present invention enables the creation of Expert Agents and the mastery of these agents through the relatively simple provision of primarily non-technical application-specific content by ordinary people. In the physical world, this is tantamount to creating an infinite supply of surrogate human beings who pre-possess useful expertise and merely need to be told where to apply that expertise. The practical and economic benefits of the present invention are thus enormous.

Although a current best embodiment of the present invention has been described in detail, it should be understood that various changes, substitutions, and alterations could be made and/or implemented without departing from the principles and the scope of the invention, including, but not limited to the following:

Changes in any or all aspects of the illustrative Expert Coach, for example: pedagogical strategy, motivational tactics, dimensions for individualizing learning paths, personalization style, personality, conversational manner, animation, appearance, voice quality, ability to make use of different types of learning objects, assessment and feedback techniques, etc;

Substituting alternative platforms, channels, or media to enable interaction between an Agent and a user, for example: phone, PDA, voice, vision, TV, robots, etc.

Substituting another language for communication between an Expert Agent and a user, including natural or artificial languages.

Substitution of different types of expertise to create different types of Expert Agents, for example Agents with Expertise for: Sales, Customer Service, Interviewing, Surveying, Negotiating, Entertaining, Persuading, Influencing, Information Acquisition, Help, Role Play, Advising, Communicating, Partnering, Supporting, Consoling, Empathizing, Parenting, etc;

Changes in the amount or type of application-independent content that is built in to an Expert Agent or the amount or type of application-specific information that can be used;

Substitution of an alternative technology for the underlying Imp Engine software and technology on which the present embodiment was implemented;

Substitution of an alternative approach to the look and feel, underlying technology, or general approach to providing application-specific information to an Expert Agent;

Substitution of compiled code for interpreted code;

Substitution of functionality compiled into hardware for functionality originally taught as being implemented in software;

Substitution of an inanimate entity for the user in interactions performed by an Expert Agent.

Following the last substitution, we note that the present invention also can be usefully deployed as a “Universal Adaptor,” enabling an agent to communicate with another similarly empowered entity, where the second entity may be a human being or another inanimate entity, such as a computer, device, toy, machine, etc. In this application as a Universal Adaptor, the invention addresses one of the most vexing and economically significant challenges of modern technology: device inter-operation. Examples of situations where device inter-operation is required include: enabling a new e-commerce system to inter-operate with a legacy customer database; enabling a robot developed by company A to inter-operate with a smart building developed by company B; enabling a consumer-delegated bidding agent to inter-operate with a number of online auction sites.

Although industry and government have invested and spent many person-decades and many millions of dollars on efforts to enable computers and other electronic devices to interact usefully with one another, the academic and commercial achievements in this area have been modest. Typical efforts have focused on techniques that formalize inter-operation protocols, syntax, and semantics. These techniques are intellectually sophisticated; incomprehensible to most people; applicable to only a small range of applications; difficult, time-consuming, and expensive to implement; not generalizable; prone to error; and rapidly rendered obsolete.

By contrast, the present invention enables an inanimate entity to inter-operate with another entity, whether human or inanimate, the same way that people do: by talking about it, interviewing and explaining themselves to one another, identifying areas of commonality or complementary, and determining whether and how they can “do business” together.

Consider the following model human-human conversation and an abstractly analogous machine-machine interaction, both using conversational dialogue to enable inter-operation between the participants:

Model use of conversational dialogue to enable inter-operation between two human agents:

A: “I'm very tired, but I guess that's not surprising since I played 6 sets of tennis today.

B: “I love tennis.”

A: “Really. Would you like to play sometime?”

B: “Sure. How about tomorrow, at 2 pm at my club, the PAC?”

A: “I am busy tomorrow.”

B: “How about Tuesday at 2 pm?”

A: “It's a date.”

Analogous use of conversational dialogue to enable inter-operation between two electronic agents:

A: “I want to buy ladies shoes.”

B: “I sell ladies shoes. How much do you want to spend?

A: “Do you have pumps in size 6?”

B: “I have black ladies pumps in size 6. How much do you want to spend?”

A: “I want Ferragamo.”

B: “I have black ladies pumps by Ferragamo in size 6. They cost $25 .”

A: “OK. Can I pay with my VISA card?”

B: “Yes. Please tell me your VISA card number.”

As these two examples illustrate, whether the participants are human beings or inanimate entities, they can use an informal exchange of information via adaptive mixed-initiative natural language conversation to discover opportunities and achieve sophisticated levels of effective inter-operability, where all participants in an inter-operating exchange get and give information and other resources that enables them collectively to achieve some or all of their objectives.

For use as a Universal Adaptor, the present invention could be implemented as a “wrapper” or component for any entity, enabling it to converse with any other entity at whatever level is supported by their respective conversational capabilities, and thereby enabling it to seek, discover, and realize opportunities for productive inter-operation. The potential practical and economic value of this capability is enormous.

Furthermore, as illustrated above in the current best embodiment of the Expert Coach, an Expert Agent can be endowed with various kinds of expertise. Similarly, a Universal Adaptor could have particular kinds of expertise, including both expertise for inter-operating in particular ways with various other entities and expertise enabling it to effectively seek, discover, and realize opportunities for inter-operability.

In the latter case, a Universal Adaptor could have expertise for engaging another entity in a conversation aimed at discovering their joint potentials for inter-operation, including strategies for learning the other entity's capabilities and interests, informing the other entity of its own capabilities and interests, resolving differences in vocabulary or mode of expression, etc. As in the case of human-human efforts to achieve inter-operability, a device equipped with a Universal Adaptor need not “speak the same language” as an entity with which it is conversing in order to inter-operate effectively. It needs only communicate the necessary information. Like a human being seeking to interact with another human being across language or cultural boundaries, a device could search for and find a communication channel to explore inter-operation with another entity, even if that entity was much more or less sophisticated than itself or had a very different sphere of interests, through adaptive conversation, experimentation with different conversational techniques, use of alternative vocabulary, interviewing the other entity, augmenting the conversation with non-verbal props, etc. Thus, unlike most efforts to enable device inter-operation, the Universal Adaptor does not provide a specific solution to which all devices in a class must conform, but rather a process by which devices can cooperatively seek, approach, and confirm a basis of shared information to enable their inter-operation.

Moreover, a Universal Adaptor also shares the Expert Agent's capability for being customized for particular applications by a relatively simple provision of primarily non-technical application-specific content by ordinary people. This is tantamount to creating a universe of devices that pre-possess expertise for discovering and realizing opportunities for useful inter-operation with people or with one another and merely need to be told where to apply that expertise. The practical and economic benefits of the present invention are thus enormous.

Accordingly, the scope of the present invention should be determined by the following claims and their legal equivalents.

Appendix 1. Set of Data Transfer commands for STOW Runtime API

LMSInitialize( )

This function indicates to the API Adapter that the SCO is going to communicate with the LMS. It allows the LMS to handle LMS specific initialization issues. It is a requirement of the SCO that it call this function before calling any other API functions.

LMSFinish( )

The SCO must call this when it has determined that it no longer needs to communicate with the LMS, if it successfully called LMSInitialize at any previous point.

LMSGetValue( )

This function allows the SCO to obtain information from the LMS. It is used to determine:

Values for various categories (groups) and elements in the data model

The version of the data model supported

Whether a specific category or element is supported

The number of items currently in an array or list of elements.

The complete data element name and/or keywords are provided as a parameter. The current value of the requested data model parameter is returned. Only one value—always a string—is returned for each call.

LMSSetValue( )

This function allows the SCO to send information to the LMS. The API Adapter may be designed to immediately forward the information to the LMS, or it may be designed to forward information based on some other approach. This function is used to set the current values for various categories (groups) and elements in the data model. The data element name and its group are provided as a parameter. The newly desired value of the data element is included as the second parameter in the call. Only one value is sent with each call.

Commands to defer until future STOW implementation:

GetLastError( )

LMSGetErrorString( )

LMSGetDiagnostic( )

Appendix 2. Subset of AICC CMI Data Model

cmi.core._children The children keyword is used to determine all of the elements in the core category that are supported by the LMS. If an element has no children, but is supported, an empty string is returned. If an element is not supported, an empty string is returned. A subsequent request for last error can verify that the element is not supported.

cmi.core.student_id Unique alpha-numeric code/identifier that refers to a single user of the LMS system.

cmi.core.student_name Normally, the official name used for the student on the course roster. A complete name, not just a first name.

cmi.core.entry Indication of whether the student has been in the SCO before.

cmi.core.total_time Accumulated time of all the student's sessions in the SCO.

cmi.core.session_time This is the amount of time in hours, minutes and seconds that the student has spent in the SCO at the time they leave it. That is, this represents the time from beginning of the session to the end of a single use of the SCO.

cmi.objectives Identifies how the student has performed on individual objectives covered in the SCO. Children of cmi.objectives: id, score, status

cmi.objectives._children The children keyword is used to determine all of the elements in the cmi.objectives category that are supported by the LMS. If an element has no children, but is supported, an empty string is returned. If an element is not supported, there is no return. A subsequent request for last error can verify that the element is not supported.

cmi.objectives._count The _count keyword is used to determine the current number of records in the cmi.objectives list. The total number of entries is returned. If the SCO does not know the count of the cmi.objectives records, it can begin the current student count with 0. This would overwrite any information about objectives currently stored in the first index position. Overwriting or appending is a decision that is made by the SCO author when he/she creates the SCO.

cmi.objectives.n.id An internally, developer defined, SCO specific identifier for an objective.

cmi.objectives.n.score Has children raw, min, max

cmi.objectives.n.score._children The children keyword is used to determine all of the elements in the cmi.objectives.n.score category that are supported by the LMS. If an element has no children, but is supported, an empty string is returned. If an element is not supported, there is no return. A subsequent request for last error can verify that the element is not supported.

cmi.objectives.n.score.raw Numerical representation of student performance after each attempt on the objective. May be unprocessed raw score.

cmi.objectives.n.score.max The maximum score or total number that the student could have achieved on the objective.

cmi.objectives.n.score.min The minimum score that the student could have achieved on the objective.

What is claimed is:

1. A method for producing a customizable expert agent, said method comprising:
generating a computer-controlled agent;
endowing said agent with application-independent expertise that can be applied in at least two different applications; and
providing customizing means for customizing said expert agent with application-specific information, thereby producing said customizable expert agent.

2. The method of claim 1, wherein
said application-independent expertise comprises interaction expertise for interacting with a user.

3. The method of claim 2, wherein
said interaction expertise is a coaching expertise, influencing expertise, advising expertise, teaching expertise, persuading expertise, interviewing expertise, entertaining expertise, negotiating expertise, information acquisition expertise, assistance expertise, customer service expertise, sales expertise, relationship expertise, financial expertise, health expertise, medical expertise, legal expertise, consulting expertise, role playing expertise, or communication expertise.

4. The method of claim 3, wherein
said customizable expert agent having said coaching expertise is capable of coaching a behavior of said user, and wherein
said coaching includes monitoring said behavior, directing said user to practice said behavior, evaluating said behavior, providing feedback on said behavior, teaching said behavior, recommending a learning activity related to said behavior, influencing an affect of said user, personalizing an interaction with said user, or a combination thereof.

5. The method of claim 4, wherein
said monitoring includes observing correctness of said behavior, observing a feature of said behavior, observing a detail of said behavior, or a combination thereof.

6. The method of claim 4, wherein
said practice comprises being quizzed on said behavior, interacting with a practice entity, or a combination thereof.

7. The method of claim 6, wherein
said practice entity is a human being, a test, or a simulation.

8. The method of claim 7, wherein
said test is a multiple-choice test, short answer test, or true/false test.

9. The method of claim 7, wherein
said simulation being a product simulation or process simulation comprises a role-play simulation with a mixed-initiative natural language conversation between said user and a virtual role-player, and wherein
said simulation exhibits a different behavior on a different assessment occasion.

10. The method of claim 4, wherein
said evaluating is classifying said behavior as being desirable or undesirable, classifying said behavior as being correct or incorrect, classifying said behavior on one of a plurality of categorical scales, or classifying said behavior on a numerical scale, based on a result obtained from an assessment instrument.

11. The method of claim 10, wherein
said assessment instrument is a test or a simulation.

12. The method of claim 11, wherein
said test is a multiple-choice test, short answer test, or true/false test.

13. The method of claim 11, wherein
said simulation being a product simulation or process simulation comprises a role-play simulation with a mixed-initiative natural language conversation between said user and a virtual role-player, and wherein
said simulation exhibits a different behavior on a different assessment occasion.

14. The method of claim 4, wherein
said feedback is a positive feedback, a negative feedback, or a combination thereof.

15. The method of claim 4, wherein
said feedback comprises praise, correction, encouragement, motivation, criticism, and any comments useful in improving said behavior.

16. The method of claim 4, wherein
said teaching comprises describing, demonstrating, motivating, and explaining said behavior.

17. The method of claim 4, wherein
said learning activity comprises reviewing examples or study material related to said behavior, identifying incorrectness of said behavior, and improving or correcting said behavior.

18. The method of claim 4, wherein
said influencing comprises motivating, encouraging, consoling, reassuring, or celebrating.

19. The method of claim 4, wherein
said personalizing comprises using a known fact about said user.

20. The method of claim 19, wherein
said known fact about said user is an objective fact of said user's name, age, gender, height, weight, ethnic origins, or geographic location.

21. The method of claim 19, wherein
said known fact about said user is a user preference on learning style, conversation pace, learning pace, feedback style, presentation style, teaching style, order of coaching activities, degree of formality, duration of a coaching session, use of alternative media, rate of progress, level of difficulty, type of practice, or type of assessment.

22. The method of claim 19, wherein
said known fact about said user relates to a relationship between said user and said coach, a coaching experience, or a coaching subject, wherein
said relationship is characterized as acquaintance, and wherein
said coaching experience is a date of a coaching event, a number of coaching events, a duration of a coaching event, a level of difficulty of a coaching event, a success of a coaching event, or a combination thereof.

23. The method of claim 3, wherein
said customizable expert agent having said influencing expertise is capable of influencing a behavior or a state of said user.

24. The method of claim 3, wherein
said customizable expert agent having said role playing expertise is capable acting as a member of a class.

25. The method of claim 24, wherein
said class comprises a superior class, a subordinate class, a peer class, a provider class, or a client class of said user.

26. The method of claim 25, wherein
said superior class comprises supervisor, parent, older relative, teacher, employer, and manager.

27. The method of claim 25, wherein
said subordinate class comprises student, child, younger relative, employee, trainee, and supervisee.

28. The method of claim 25, wherein
said peer class comprises spouse, partner, roommate, sibling, near-age relative, boyfriend, girlfriend, any person in an intimate relationship, colleague, team mate, friend, neighbor, and acquaintance.

29. The method of claim 25, wherein
said provider class comprises physician, therapist, consultant, advisor, instructor, law officer, customer service representative, and sales person.

30. The method of claim 25, wherein
said client class comprises patient, customer, citizen, resident, consumer, and advisee.

31. The method of claim 3, wherein said communication expertise comprises linguistic expertise and conversation expertise such that said customizable expert agent is capable of:
understanding natural language input from said user;
generating natural language output to said user; and
engaging in a natural language exchange with said user.

32. The method of claim 1, wherein
said application-independent expertise comprises interaction expertise for interacting with a device.

33. The method of claim 32, wherein
said device has interaction expertise for interacting with said agent.

34. The method of claim 32, wherein
said agent interacts with said device with a goal related to inter-operation between said agent and said device.

35. A system for implementing a customizable expert agent, comprising:
means for generating a computer-controlled agent;
means for integrating said agent with application-independent expertise thereby producing an expert agent; and
means for customizing said expert agent with application-specific information, thereby producing said customizable expert agent.

36. The system of claim 35, wherein
said application-independent expertise comprises interaction expertise for interacting with a user.

37. The system of claim 36, wherein
said interaction expertise is a coaching expertise, influencing expertise, advising expertise, teaching expertise, persuading expertise, interviewing expertise, entertaining expertise, negotiating expertise, information acquisition expertise, assistance expertise, customer service expertise, sales expertise, relationship expertise, financial expertise, health expertise, medical expertise, legal expertise, consulting expertise, role playing expertise, or communication expertise.

38. The system of claim 37, wherein
said customizable expert agent having said coaching expertise is capable of coaching a behavior of said user, and wherein
said coaching includes monitoring said behavior, directing said user to practice said behavior, evaluating said behavior, providing feedback on said behavior, teaching said behavior, recommending a learning activity related to said behavior, influencing an affect of said user, personalizing an interaction with said user, or a combination thereof.

39. The system of claim 38, wherein
said monitoring includes observing correctness of said behavior, observing a feature of said behavior, observing a detail of said behavior, or a combination thereof.

40. The system of claim 38, wherein
said practice comprises being quizzed on said behavior, interacting with a practice entity, or a combination thereof.

41. The system of claim 40, wherein
said practice entity is a human being, a test, or a simulation.

42. The system of claim 41, wherein
said test is a multiple-choice test, short answer test, or true/false test.

43. The system of claim 41, wherein
said simulation being a product simulation or process simulation comprises a role-play simulation with a mixed-initiative natural language conversation between said user and a virtual role-player, and wherein
said simulation exhibits a different behavior on a different assessment occasion.

44. The system of claim 38, wherein
said evaluating is classifying said behavior as being desirable or undesirable, classifying said behavior as being correct or incorrect, classifying said behavior on one of a plurality of categorical scales, or classifying said behavior on a numerical scale, based on a result obtained from an assessment instrument.

45. The system of claim 44, wherein
said assessment instrument is a test or a simulation.

46. The system of claim 45, wherein
said test is a multiple-choice test, short answer test, or true/false test.

47. The system of claim 45, wherein
said simulation being a product simulation or process simulation comprises a role-play simulation with a mixed-initiative natural language conversation between said user and a virtual role-player, and wherein
said simulation exhibits a different behavior on a different assessment occasion.

48. The system of claim 38, wherein
said feedback is a positive feedback, a negative feedback, or a combination thereof.

49. The system of claim 38, wherein
said feedback comprises praise, correction, encouragement, motivation, criticism, and any comments useful in improving said behavior.

50. The system of claim 38, wherein
said teaching comprises describing, demonstrating, motivating, and explaining said behavior.

51. The system of claim 38, wherein
said learning activity comprises reviewing examples or study material related to said behavior, identifying incorrectness of said behavior, and improving or correcting said behavior.

52. The system of claim 38, wherein
said influencing comprises motivating, encouraging, consoling, reassuring, or celebrating.

53. The system of claim 38, wherein
said personalizing comprises using a known fact about said user.

54. The system of claim 53, wherein
said known fact about said user is an objective fact of said user's name, age, gender, height, weight, ethnic origins, or geographic location.

55. The system of claim 53, wherein
said known fact about said user is a user preference on learning style, conversation pace, learning pace, feedback style, presentation style, teaching style, order of coaching activities, degree of formality, duration of a coaching session, use of alternative media, rate of progress, level of difficulty, type of practice, or type of assessment.

56. The system of claim 53, wherein
said known fact about said user relates to a relationship between said user and said coach, a coaching experience, or a coaching subject, wherein
said relationship is characterized as acquaintance, and wherein
said coaching experience is a date of a coaching event, a number of coaching events, a duration of a coaching event, a level of difficulty of a coaching event, a success of a coaching event, or a combination thereof.

57. The system of claim 37, wherein
said customizable expert agent having said influencing expertise is capable of influencing a behavior or a state of said user.

58. The system of claim 37, wherein
said customizable expert agent having said role playing expertise is capable acting as a member of a class.

59. The system of claim 58, wherein
said class comprises a superior class, a subordinate class, a peer class, a provider class, or a client class of said user.

60. The system of claim 59, wherein
said superior class comprises supervisor, parent, older relative, teacher, employer, and manager.

61. The system of claim 59, wherein
said subordinate class comprises student, child, younger relative, employee, trainee, and supervisee.

62. The system of claim 59, wherein
said peer class comprises spouse, partner, roommate, sibling, near-age relative, boyfriend, girlfriend, any person in an intimate relationship, colleague, team mate, friend, neighbor, and acquaintance.

63. The system of claim 59, wherein
said provider class comprises physician, therapist, consultant, advisor, instructor, law officer, customer service representative, and sales person.

64. The system of claim 59, wherein
said client class comprises patient, customer, citizen, resident, consumer, and advisee.

65. The system of claim 37, wherein said communication expertise comprises linguistic expertise and conversation expertise such that said customizable expert agent is capable of:
understanding natural language input from said user;
generating natural language output to said user; and
engaging in a natural language exchange with said user.

66. The system of claim 35, wherein
said application-independent expertise comprises interaction expertise for interacting with a device.

67. The system of claim 66, wherein
said device has interaction expertise for interacting with said agent.

68. The system of claim 66, wherein
said agent interacts with said device with a goal related to inter-operation between said agent and said device.

69. A computer product for producing a customizable expert agent, said customizable expert agent being an agent and having application-independent expertise and application-specific information, said computer product comprising a computer-readable medium carrying computer-executable instructions, said computer-executable instructions comprising:
program code means for generating a computer-controlled agent;
program code means for integrating said agent with application-independent expertise thereby producing an expert agent; and
program code means for customizing said expert agent with application-specific information, thereby producing said customizable expert agent.

70. The computer product of claim 69, wherein said application-independent expertise comprises interaction expertise for interacting with a user.

71. The computer product of claim 69, wherein
said application-independent expertise comprises interaction expertise for interacting with a device.

72. The computer product of claim 71, wherein
said device has interaction expertise for interacting with said agent.

73. The computer product of claim 71, wherein
said agent interacts with said device with a goal related to inter-operation between said agent and said device.

74. A method for enabling a device to inter-operate with an entity, comprising:
providing said device with a conversational capability for exchanging information with said entity.

75. The method of claim 74, wherein
said information is related to a capability of said device, an interest of said device, a capability of said entity, an interest of said entity, or a combination thereof.

76. The method of claim 74, wherein
said conversational capability comprises a strategy for said exchanging information with said entity in order to determine how said device and said entity can inter-operate.

77. The method of claim 74, wherein
said device is a Universal Adaptor endowed with specific expertise for inter-operating with a plurality of animate and inanimate entities and general expertise for effective seeking, discovering, and realizing opportunities for inter-operability therewith.

78. A computer product for enabling a device to inter-operate with an entity, said computer product comprising a computer readable medium carrying computer-executable instructions, said computer-executable instructions comprising:
program code means for providing said device with a conversational capability for exchanging information with said entity.

79. The computer product of claim 78, wherein
said information is related to a capability of said device, an interest of said device, a capability of said entity, an interest of said entity, or a combination thereof.

80. The computer product of claim 78, wherein
said conversational capability comprises a strategy for said exchanging information with said entity in order to determine how said device and said entity can inter-operate.
